(19) United States
(12) Patent Application Publication
(10) Pub. No.: US 2019/0028377 A1
(43) Pub. Date: Jan. 24, 2019

(54) TESTING DEVICE, TESTING METHOD, AND RECORDING MEDIUM

(71) Applicant: NEC Corporation, Minato-ku Tokyo (JP)

(72) Inventor: Satoshi YAMAZAKI, Tokyo (JP)

(73) Assignee: NEC Corporation, Minato-ku, Tokyo (JP)

(21) Appl. No.: 15/755,609

(22) PCT Filed: Sep. 7, 2016
(86) PCT No.: PCT/JP2016/004072

§ 371 Date: Feb. 27, 2018

(30) Foreign Application Priority Data
Sep. 11, 2015 (JP) 2015-179156

(51) Int. Cl. H04L 12/26; H04L 12/741; H04L 12/707; H04L 12/751; H04L 12/24

(52) U.S. Cl. CPC H04L 43/50; H04L 45/745; H04L 41/0631; H04L 45/02; H04L 45/22

(57) ABSTRACT

A testing device according to the present invention includes: a route calculator that generates supplementary-setting-table information including a route from a communication start point to a communication end point based on topology information, and setting table information by adding the supplementary-setting-table information to a communication request information indicating a content of the test; a test information generator that generates test information for the test target based on the setting table information and additional test information with considering a time slot in the path addressing communication, and transmits the test information to the test target; and a failure cause identifier that receives test result information from the test target, and generates the additional test information based on the test result information, the supplementary-setting-table information, and the topology information.

### TECHNICAL FIELD

The present invention relates to a test of a device, and particularly, to a testing device, a testing method, and a recording medium for testing a device within a network.

### BACKGROUND ART

As a standard specification of an interface and a protocol of data communication between devices (components) mounted in an artificial satellite such as a commercial satellite, a scientific satellite, or an interplanetary space probe, there is SpaceWire (e.g. see NPL 1). A device employing SpaceWire is reusable in a satellite having a different mission such as an observation purpose. In other words, it is possible to shorten a delivery time regarding development of a satellite by using a device in conformity with SpaceWire.

The SpaceWire specification, however, has a high degree of freedom in network designing. Therefore, test man-hours are increasing in an operation test of a device. For example, when an operation test of communication is presumed, it is possible to presume many addresses and routes as an address and a route of a transmission destination of a packet in communication. In other words, in an operation test, it is necessary to set many addresses and routes. Therefore, when an address and a route are set in a packet to be transmitted, a possibility of occurrence of an error increases. In other words, when SpaceWire is employed, it is highly likely that confirmation on reworking of an operation test based on an error occurs in an operation test of communication in a device for development.

Note that, in the following description, a network constituted by devices (components) including an interface in conformity with the SpaceWire specification is referred to as “a SpaceWire network”.

Devices constituting a SpaceWire network include various types of devices mounted in an artificial satellite, specifically, a satellite-mounted device such as a power supply device, an observation device, and a posture device, a communication device for communicating with an earth station, and a system control device for controlling an entire system within a satellite. The system control device controls the devices constituting the SpaceWire network by using a network management function based on the SpaceWire specification.

Next, a SpaceWire network is described with reference to the drawings. In the following description, a symbol of a numerical value (e.g. “router 206”) is used as a symbol when same devices are generically described. On the other hand, a symbol using a numerical value and an alphabet (e.g. “router 206A”) is used as a symbol when an individual device is described.

Further, in the following description, an artificial satellite is referred to and described as an example of a device using a SpaceWire network.

FIG. 1 is a block diagram illustrating an example of a configuration of a SpaceWire network 200. The SpaceWire network 200 includes a system control device 201, a communication device 202, a power supply device 203, a posture control device 204, an observation control device 205, routers 206, posture devices 214, and observation devices 215. Note that the number of devices illustrated in FIG. 1 is an example. The SpaceWire network 200 may include one or more respective devices.

As described above, the system control device 201 controls each device by using a command. The communication device 202 performs predetermined communication with an unillustrated earth station or another artificial satellite as a communication partner. The power supply device 203 supplies electric power to each component (each device). The posture control device 204 controls the posture devices 214, and controls a posture of the artificial satellite. The observation control device 205 controls the observation devices 215, and performs various types of observation. The routers 206 implement connection between the respective components. The posture devices 214 respectively change a posture of the artificial satellite with respect to a predetermined direction or a rotating direction. The observation devices 215 respectively perform predetermined observation.

An operation test of communication of an artificial satellite before launching is classified into a plurality of tests, based on a range of a test. For example, a system test is a test (integration test) as to whether or not consistent communication is possible from the system control device 201 to all satellite-mounted devices. Further, a subsystem test is a test as to whether or not a satellite-mounted device group (subsystem) included in a predetermined range is communicable. The satellite-mounted device group (subsystem) as a target in the subsystem test is, for example, device groups indicated by using broken lines in FIG. 1. In FIG. 1, specifically, the satellite-mounted device group surrounded by the broken line is a subsystem constituted by the observation control device 205 and the observation devices 215, or a subsystem constituted by the posture control device 204 and the posture devices 214.

Communication by the SpaceWire specification mainly uses a source routing method (path addressing communication) in which communication is performed by writing information indicating an address of each device into a packet header. Path addressing communication is communication such that an address of a device to be relayed is designated, in addition to addresses of a device at a start point (a transmission source or a sender) and a device at an end point (a transmission destination or a recipient). Note that an address in the path addressing communication is information indicating a position (e.g. a port number) within a network. Therefore, in the path addressing communication, for example, a routing table used in transmission control protocol/internet protocol (TCP/IP) is not necessary. Hereinafter, an address used in the path addressing communication is referred to as “a path address”. Route change in the path addressing communication is performed based on a change in indication of a path address included in a packet header.

The path addressing communication is described with reference to the drawings. FIG. 2 is a diagram for describing the path addressing communication. A system illustrated in FIG. 2 includes two mounted devices 210 and two routers 206. In FIG. 2, the two mounted devices 210 are connected via the two routers 206. Further, a router 206X includes a port (hereinafter, referred to as “a port 1”) connected to a mounted device 210A and having a path address “1”, and a port (hereinafter, referred to as “a port 2”) connected to a router 206Y and having a path address “2”. Further, the router 206Y includes a port (hereinafter, referred to as “a port 3”) connected to the router 206X and having a path address “3”, and a port (hereinafter, referred to as “a port 4”) connected to a mounted device 210B and having a path address “4”.

When each of the mounted devices 210 communicates a packet with another one of the mounted devices 210, the mounted device 210 writes, in a packet header of a packet to be transmitted, a path address (address information) allocated to each port in a device (in this case, the router 206) through which the packet passes.

On the other hand, a device (router 206) that receives a packet transmits the packet to a next device from a port of a leading path address in the packet header. However, the router 206 deletes the leading path address from the packet header associated with the path address of the port, before the packet is transmitted from the port. In other words, each time a packet passes through the router 206, a leading path address is deleted from a packet header.

For example, in FIG. 2, when the mounted device 210A transmits a packet to the mounted device 210B, the mounted device 210A writes [2-4] in a packet header of the packet to be transmitted, as a path address. Herein, the path address [2-4] written in the packet header indicates that the packet passes via a port having a path address 2, and via a port having a path address 4. In other words, in the indication [p-q] in a path address, “p” denotes a leading path address. Note that the number of path addresses is not limited to two, but may exceed two. For example, when the number of path addresses is three, the path address is written as [p-q-r]. In this case, “p” denotes a leading path address, “q” denotes a relay path address, and “r” denotes a last path address.

More specifically, the aforementioned operation is described as follows. First of all, the mounted device 210A sets (writes) [2-4] as a path address in a packet header, and transmits a packet to the router 206X. A port of the router 206X in this transmission is not specifically limited. In FIG. 2, however, since the mounted device 210A is connected to the port 1 of the router 206X, the packet arrives at the port 1 of the router 206X.

The router 206X transmits the packet from a port (in this case, “port 2”) of the first path address in the packet header of the received packet. When the packet is transmitted, however, the router 206X deletes a leading path address (in this case, the path address “2”) from the packet header. Consequently, the path address in the packet header becomes “4”. In other words, when the packet is passed, the router 206X deletes the leading path address (in this case, the path address “2”) from the packet header, and transfers (transmits) the packet from a port (in this case, the port 2) associated with the deleted path address.

The port 2 of the router 206X is connected to the port 3 of the router 206Y. Therefore, the router 206Y receives the packet. Then, the router 206Y transmits the packet from a port (in this case, the port 4) of the first path address in the packet header of the received packet. When the packet is transmitted, however, the router 206Y deletes a leading path address (in this case, the path address “4”) from the packet header. Consequently, the path address in the packet header becomes empty (empty set). In other words, when the packet is passed, the router 206Y deletes the leading path address (in this case, the path address “4”), and transfers (transmits) the packet from a port (in this case, the port 4) associated with the deleted path address.

The port 4 of the router 206Y is connected to the mounted device 210B. Therefore, the mounted device 210B receives the packet having an empty packet header. The packet having an empty packet header is a packet that is not transferred, in other words, a packet addressed to the mounter 210B. In this way, the mounted device 210B receives the packet addressed to the own device.

In this way, by setting, in a packet header, a path address of a port (transmission port) of the router 206 through which a packet is transmitted to the mounted device 210B being a transmission destination of the packet, the mounted device 210A is able to transmit the packet to the mounted device 210B.

Likewise, when a packet is transmitted to the mounted device 210A, the mounted device 210B may set a path address [3-1] in a packet header of the packet.

Further, in the SpaceWire specification, a time interval of 15.625 ms called a time slot is defined. Sixty-four time slots equal to one second. Therefore, in the SpaceWire specification, a communication packet is allocated to a predetermined time slot, and a transmission timing of a packet to be transmitted is controlled with a predetermined period (e.g. a period of one second) or at a predetermined timing (e.g. see NPL 2).

A control device in conformity with the SpaceWire specification holds a time slot table in which a packet to be transmitted is allocated, and performs communication between devices using a packet, in accordance with the held time slot table.

Packet generation and a simulation tool for a test in a SpaceWire network (intra-satellite network) are proposed (e.g. see NPL 3). In NPL 3, first of all, packet header information including path addresses associated with the number of packets for use in a test is stored in a memory. Thereafter, in NPL 3, a test packet is generated by referring to the packet header information stored in the memory. In NPL 3, a connection test of a SpaceWire network (intra-satellite network) is implemented by using the generated packet. Further, in NPL 3, a command is stored in the memory together with the packet header information. In NPL 3, control of repeating transmission of a same packet (a packet relating to a command) is implemented by using the command stored in the memory.

Further, a scheduling tool in a SpaceWire network is proposed (e.g. see NPL 4). In NPL 4, a path address from a device as a packet transmission source to a destination device is calculated, based on topology information in a SpaceWire network, and communication request information. Further, a time slot for use in packet communication is allocated. Note that, in NPL 4, an extensible markup language (XML) format is used as a format of the topology information and the communication request information.

Further, a system for automating a packet passing test in a network, as a target, where TCP/IP communication by the Ethernet® is performed is proposed (e.g. NPL 5). In NPL 5, route information is extracted from a routing table stored by a router included in a target network, and a passing route and a value allocatable to a packet header included in a packet are calculated based on the route information. Further, in NPL 5, the calculation result is stored in a database for test packet generation. In NPL 5, automation of a passing test is implemented by using the database. Further, NPL 5 includes a process for reducing a load in the test. Further, in NPL 5, a cause of failure is identified based on an analysis on a test result.

Note that, as a prior art document relating to SpaceWire, PTL 1 is present in addition to the aforementioned documents.

Further, as prior art documents relating to a test in a network, PTLs 2 and 3 are present.

### CITATION LIST

### Patent Literature

[PTL 1] Japanese Laid-open Patent Publication No. 2010-219819
[PTL 2] Japanese Laid-open Patent Publication No. 2012-129930
[PTL 3] Japanese Laid-open Patent Publication No. H03-108858

### Non Patent Literature

[NPL 1] SpaceWire Standard ECSS-E-ST-50-12C (European Cooperation for Space Standardization (ECSS)), Jul. 21, 2008
[NPL 2] Steve Parkes, Albert Ferrer, Stuart Mills, Alex Mason, “SpaceWire-D: Deterministic Data Delivery with SpaceWire”, Proceedings of International SpaceWire Conference 2010, February 2010
[NPL 3] Antonis Tavoularis, Vassilis Vlagkoulis, Nikos Pogkas, Vangelis Kollias, Kostas Marinis, “iSAFT-PVS: Recording, simulation & traffic generation at full network load”, SpaceWire Conference (SpaceWire), 2014 International (IEEE), pp. 1 to 7, Sep. 22 to 26, 2014
[NPL 4] Mitsutaka TAKADA, Hiroaki TAKADA, Takayuki YUASA, et al., “Development of Software Platform for Guaranteeing the Real-Time Property of SpaceWire”, Proceedings of the 57th Space Sciences and Technology Conference, pp. 6, Oct. 9, 2013
[NPL 5] Hongyi Zeng, Peyman Kazemian, George Varghese, Nick McKeown, “Automatic test packet generation”, Proceedings of the 8th international conference on Emerging networking experiments and technologies, ACM, pp. 241 to 252, 2012

### SUMMARY INVENTION

### Technical Problem

In NPL 3, a person who performs a test is required to manually register, in a memory, packet header information in a packet necessary for the test. Therefore, in NPL 3, there is an issue that a human error may occur in generation of test information.

NPLs 1, 2, and 4 are documents relating to the SpaceWire specification, and cannot solve the aforementioned issue in a test.

Further, NPL 5 discloses a technique for automating a test with respect to TCP/IP communication. However, TCP/IP communication does not handle path addressing communication used in SpaceWire. Further, TCP/IP communication does not handle a time slot in the aforementioned SpaceWire. In other words, NPL 5 is not applicable to a SpaceWire network. Therefore, NPL 5 cannot solve the aforementioned issue.

PTL 1 discloses a technique for converting an electrical signal. However, PTL 1 fails to disclose a technique relating to test information in packet communication. Therefore, PTL 1 cannot solve the aforementioned issue.

PTL 2 discloses a technique relating to session initiation protocol (SIP). The SIP uses the internet protocol (IP). Therefore, PTL 2 is not applicable to a SpaceWire network using path addressing communication and a time slot, which are not handled by the SIP. For example, in PTL 2, packet collision in a test may occur, since a time slot is not considered. In other words, in PTL 2, there is an issue that it is not possible to perform an appropriate test in communication using a time slot, in addition to the aforementioned issue.

PTL 3 discloses a technique for analyzing a failure (error) of a system, and performing an additional test, based on the analysis result. However, the technique disclosed in PTL 3 is not a technique relating to a test associated with path addressing communication and a time slot. In other words, in PTL 3, packet collision is caused to occur in an additional test. Further, PTL 3 fails to disclose automatically generating test information. In other words, in PTL 3, there is an issue that it is not possible to perform an appropriate additional test, in addition to the aforementioned issue.

As described above, in NPLs 1 to 5, and in PTLs 1 to 3, there is an issue that a human error may occur when test information (packet) is generated in path addressing communication. Further, in NPLs 1 to 5, and in PTLs 1 to 3, there is an issue that it is not possible to perform an appropriate test and an additional test in a test on path addressing communication.

An object of the present invention is to provide a testing device, a testing method, and a recording medium that solve the aforementioned issue, prevent occurrence of a human error, and generate information for appropriately performing a test and an additional test associated with path addressing communication.

### Solution to Problem

A testing device according to an example aspect of the present invention includes: route calculation means for generating supplementary-setting-table information including information relating to a route with respect to a set of a communication start point and a communication end point, the set being a combination of a device serving as a communication start point and a device serving as a communication end point that are included in a test target, based on topology information including information indicating a connection relationship between devices included in the test target for performing path addressing communication, and setting table information being information such that, to a communication request information including information indicating a content of the test in the test target, information relating to a route with respect to a requested set of a start point and an end point, the requested set being a combination of a device serving as a start point and a device serving as an end point of a test included in the communication request information is added, based on the supplementary-setting-table information; test information generation means for generating test information being information to be referred to in the test in the test target, based on the setting table information and additional test information, by taking into consideration a time slot in the path addressing communication, and transmitting the test information to the test target; and failure cause identifying means for receiving, from the test target, test result information being a result of the test acquired by referring to the test information, and generating the additional test information being information for use when the test information generation means generates test information to be referred to in an additional test in the test target, based on the test result information, the supplementary-setting-table information, and the topology information.

A testing method according to an example aspect of the present invention includes: generating supplementary-setting-table information including information relating to a route with respect to a set of a communication start point and a communication end point, the set being a combination of a device serving as a communication start point and a device serving as a communication end point that are included in a test target, based on topology information including information indicating a connection relationship between devices included in the test target for performing path addressing communication, and setting table information being information such that, to a communication request information including information indicating a content of the test in the test target, information relating to a route with respect to a requested set of a start point and an end point, the requested set being a combination of a device serving as a start point and a device serving as an end point of a test included in the communication request information is added, based on the supplementary-setting-table information; generating test information being information to be referred to in the test in the test target, based on the setting table information and additional test information, by taking into consideration a time slot in the path addressing communication; transmitting the test information to the test target; receiving, from the test target, test result information being a result of the test acquired by referring to the test information; and generating the additional test information being information for use when test information to be referred to in an additional test in the test target is generated, based on the test result information, the supplementary-setting-table information, and the topology information.

A recording medium according to an example aspect of the present invention computer-readably records a program. The program causes a computer to execute: a process of generating supplementary-setting-table information including information relating to a route with respect to a set of a communication start point and a communication end point, the set being a combination of a device serving as a communication start point and a device serving as a communication end point that are included in a test target, based on topology information including information indicating a connection relationship between devices included in the test target for performing path addressing communication, and setting table information being information such that, to a communication request information including information indicating a content of the test in the test target, information relating to a route with respect to a requested set of a start point and an end point, the requested set being a combination of a device serving as a start point and a device serving as an end point of a test included in the communication request information is added, based on the supplementary-setting-table information; a process of generating test information being information to be referred to in the test in the test target, based on the setting table information and additional test information, by taking into consideration a time slot in path addressing communication, and transmitting the test information to the test target; and a process of receiving, from the test target, test result information being a result of the test acquired by referring to the test information, and generating the additional test information being information for use when test information to be referred to in an additional test in the test target is generated, based on the test result information, the supplementary-setting-table information, and the topology information.

### Advantageous Effects of Invention

According to the present invention, it is possible to provide advantageous effects that occurrence of a human error is prevented, and information for appropriately performing a test and an additional test associated with path addressing communication is generated.

### BRIEF DESCRIPTION OF DRAWINGS

FIG. 1 is a block diagram illustrating an example of a configuration of a SpaceWire network.

FIG. 2 is a diagram for describing path addressing communication.

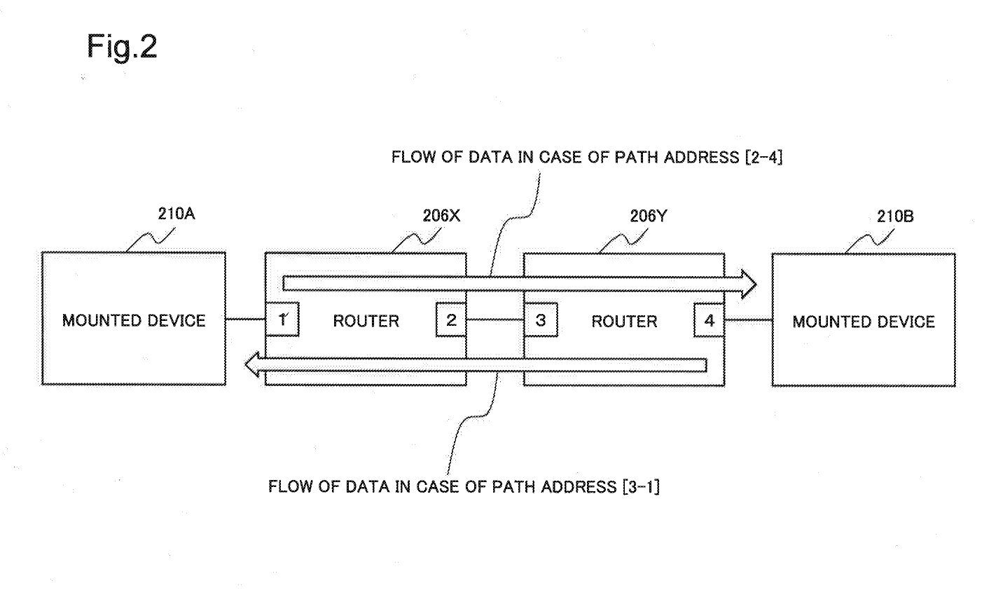

FIG. 3 is a block diagram illustrating an example of a configuration of a testing device according to a first example embodiment of the present invention.

FIG. 4 is a diagram schematically illustrating a test in the SpaceWire network.

FIG. 5 is a diagram illustrating an example of topology information for use in describing the first example embodiment.

FIG. 6 is a diagram illustrating an example of communication request information for use in describing the first example embodiment.

FIG. 7 is a diagram illustrating an example of setting table information according to the first example embodiment.

FIG. 8 is a detailed diagram of a part of the SpaceWire network for use in describing the first example embodiment.

FIG. 9 is a diagram illustrating an example of supplementary-setting-table information according to the first example embodiment.

FIG. 10 is a block diagram illustrating an example of a configuration of a test information generation unit according to the first example embodiment.

FIG. 11 is a diagram illustrating an example of setting table information in which a time slot is allocated according to the first example embodiment.

FIG. 12 is a diagram illustrating an example of test information according to the first example embodiment.

FIG. 13 is a block diagram illustrating an example of a configuration of a failure cause identifying unit according to the first example embodiment.

FIG. 14 is a diagram illustrating an example of test report information according to the first example embodiment.

FIG. 15 is a flowchart illustrating an outline of an operation of the testing device according to the first example embodiment.

FIG. 16 is a flowchart illustrating an example of an operation of a route calculation unit according to the first example embodiment.

FIG. 17 is a flowchart illustrating an example of an operation of the test information generation unit according to the first example embodiment.

FIG. 18 is a flowchart illustrating an example of an operation of a time slot allocation unit according to the first example embodiment.

FIG. 19 is a flowchart illustrating an example of an operation of a test information output unit according to the first example embodiment.

FIG. 20 is a flowchart illustrating an example of an operation of the failure cause identifying unit according to the first example embodiment.

FIG. 21 is a diagram illustrating an example of test result information according to the first example embodiment.

FIG. 22 is a diagram illustrating an example of additional test information according to the first example embodiment.

FIG. 23 is a block diagram illustrating an example of another configuration of the testing device according to the first example embodiment.

### DESCRIPTION OF EMBODIMENTS

Next, an example embodiment of the present invention is described with reference to the drawings.

Note that the drawings describe the example embodiment of the present invention. The present invention, however, is not limited by description of the drawings. Further, same constituent elements throughout the drawings are indicated by same reference numerals, and repeated description thereof may be omitted.

Further, in the drawings for use in the following description, description of a configuration of a portion which is not related to description of the present invention may be omitted, and illustration thereof may be omitted.

Further, as far as a test target in a testing device according to the present example embodiment is a network using path addressing communication, the network is not limited to a SpaceWire network. In the following description, however, description is made by using a SpaceWire network as an example.

Further, a test target in the testing device according to the present example embodiment is not necessarily limited to a subsystem. The following description, however, is made by using a test of a subsystem.

Further, in the following description, description is made based on a premise that each component transmits (outputs) necessary information to another component. An operation of the example embodiment of the present invention, however, is not necessarily limited to such an operation. For example, the example embodiment of the present invention may include an unillustrated storage unit. Further, each of the components may be such that generated (calculated) or received information is stored in the storage unit, and necessary information is read from the storage unit.

### First Example Embodiment

[Description of Configuration]

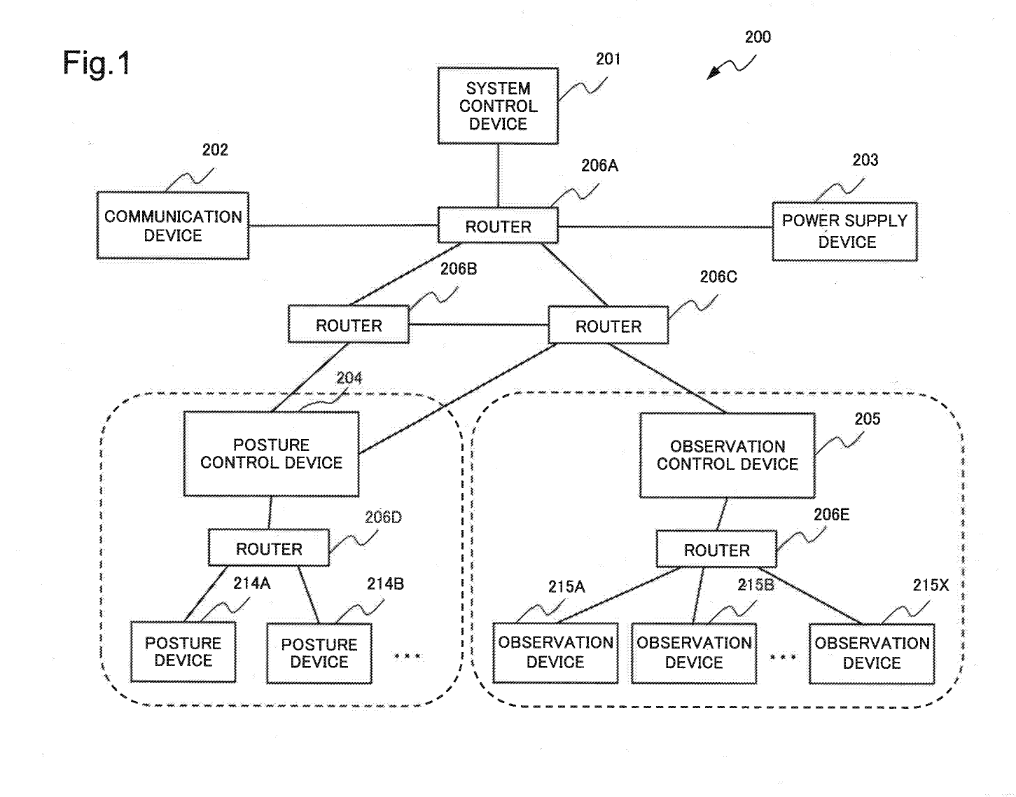

Next, a testing device 100 according to the first example embodiment of the present invention is described in detail with reference to the drawings. The testing device 100 according to the first example embodiment processes information relating to a test in a subsystem included in the SpaceWire network 200 as illustrated in FIG. 1.

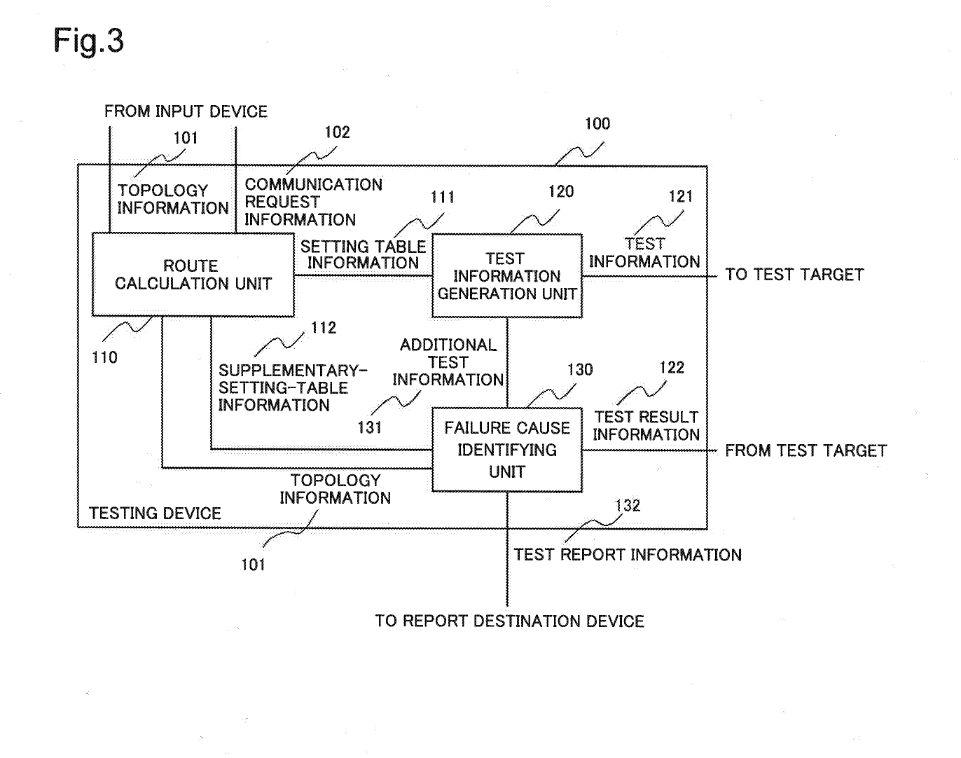

FIG. 3 is a block diagram illustrating an example of a configuration of the testing device 100 according to the first example embodiment of the present invention. The testing device 100 includes a route calculation unit 110, a test information generation unit 120, and a failure cause identifying unit 130.

The testing device 100 generates test information 121 being information to be used (referred to) in a subsystem test by the SpaceWire network 200 which is an object of a test (test target), and transmits the test information 121 to the SpaceWire network 200. Further, the testing device 100 receives, from the SpaceWire network 200, test result information 122 being information relating to a result of a test. Further, the testing device 100 generates the test information 121 to be referred to by an additional test in the SpaceWire network 200, based on the test result information 122, and transmits the test information 121 to the SpaceWire network 200. Further, the testing device 100 generates and outputs test report information 132 being information to be reported to a predetermined device based on the test result information 122.

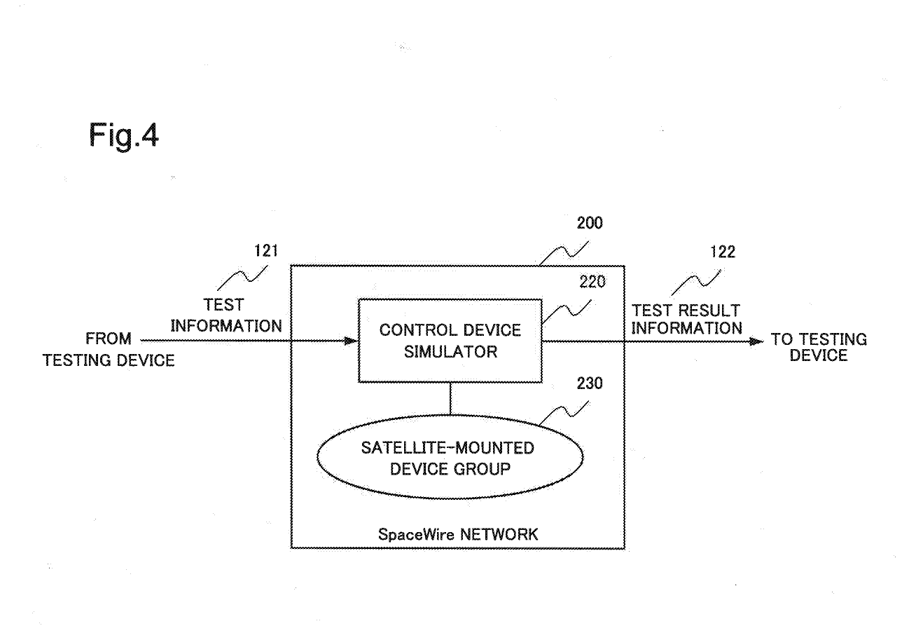

FIG. 4 is a diagram schematically illustrating a test in the SpaceWire network 200. FIG. 4 illustrates a subsystem test with respect to a predetermined satellite-mounted device group 230 included in the SpaceWire network 200. Therefore, the SpaceWire network 200 includes, in addition to the satellite-mounted device group 230 being a target in a subsystem test, a control device simulator 220 for controlling the satellite-mounted device group 230 in the subsystem test. The testing device 100 transmits the test information 121 to the control device simulator 220. The control device simulator 220 performs a subsystem test of the satellite-mounted device group 230 by using (referring to) the test information 121. Then, the control device simulator 220 transmits, to the testing device 100, the test result information 122 being a result of the subsystem test. In other words, the testing device 100 receives the test result information 122 from the control device simulator 220.

Note that a device included in the satellite-mounted device group 230 being a target in a subsystem test is not specifically limited. For example, the satellite-mounted device group 230 may be a subsystem constituted by the observation control device 205 and the observation devices 215 illustrated in FIG. 1, or a subsystem constituted by the posture control device 204 and the posture devices 214 illustrated in FIG. 1, which is already described. In this way, the satellite-mounted device group 230 may include a device and routers 206 in a predetermined range included in the SpaceWire network 200. Note that a control device for performing control during an actual operation may perform a function as the control device simulator 220. For example, the posture control device 204 or the observation control device 205 illustrated in FIG. 1 may be operated as the control device simulator 220.

Next, components included in the testing device 100 are described in further detail with reference to FIG. 3. Note that in description of each component, associated information is also described with reference to the drawings.

First of all, the route calculation unit 110 is described.

The route calculation unit 110 acquires topology information 101 and communication request information 102. The topology information 101 and the communication request information 102 will be described later in detail. A device from which the route calculation unit 110 acquires the topology information 101 and the communication request information 102 is not specifically limited. For example, a person who performs a subsystem test may transmit the aforementioned information from an unillustrated input device to the testing device 100. Alternatively, a person who performs a subsystem test may directly operate the testing device 100, and input the aforementioned information.

The route calculation unit 110 extracts all combinations (a set of a communication start point and a communication end point) of a device serving as a transmission source (start point) and a device serving as a destination (an end point or a transmission destination), which are communicable with each other, based on the topology information 101. The set of a communication start point and a communication end point to be extracted herein includes a combination of a transmission source and a destination, which is not included in the communication request information 102. Then, the route calculation unit 110 generates supplementary-setting-table information 112 including information relating to the set of a communication start point and a communication end point. Details on the supplementary-setting-table information 112 will be described later. The route calculation unit 110 outputs the generated supplementary-setting-table information 112 to the failure cause identifying unit 130. The route calculation unit 110 outputs the topology information 101 together with the supplementary-setting-table information 112 to the failure cause identifying unit 130.

Note that a combination of a device being a transmission source (start point) and a device being a destination (an end point or a transmission destination) included in the communication request information 102 is referred to as “a requested set of a start point and an end point” hereinafter.

Further, the route calculation unit 110 generates setting table information 111 for use when the test information generation unit 120 generates the test information 121, based on the topology information 101, the communication request information 102, and the supplementary-setting-table information 112. The route calculation unit 110 calculates (generates) information (a path address and a reply path address) relating to a route of a packet for use in a subsystem test, when the setting table information 111 is generated. The route calculation unit 110 generates the setting table information 111 from the communication request information 102 by using information (route information) on a result of the calculation. Then, the route calculation unit 110 outputs the setting table information 111 to the test information generation unit 120.

Next, information associated with the route calculation unit 110 is described.

First of all, the topology information 101 is described.

The topology information 101 is information (connection information) relating to connection of devices included (such as each of control units, the routers 206, the posture devices 214, and the observation devices 215) in the SpaceWire network 200. Herein, the connection information is information indicating to which one of the other devices, each device including the routers 206 is connected. The topology information 101 may include other information (e.g. a performance or a function) relating to a device included in the SpaceWire network 200.

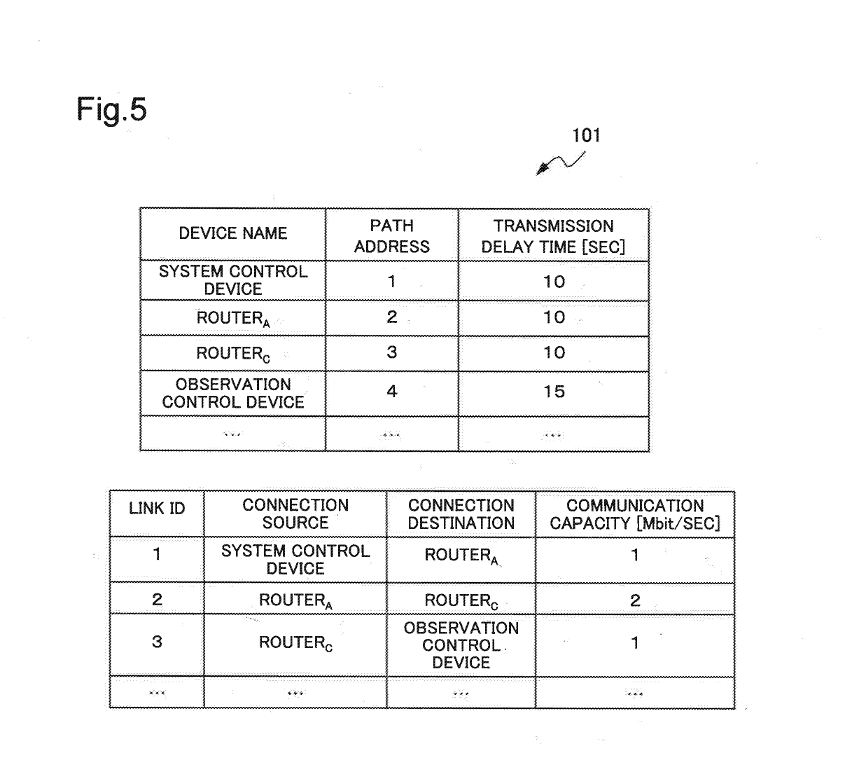

FIG. 5 is a diagram illustrating an example of the topology information 101 used in the present description.

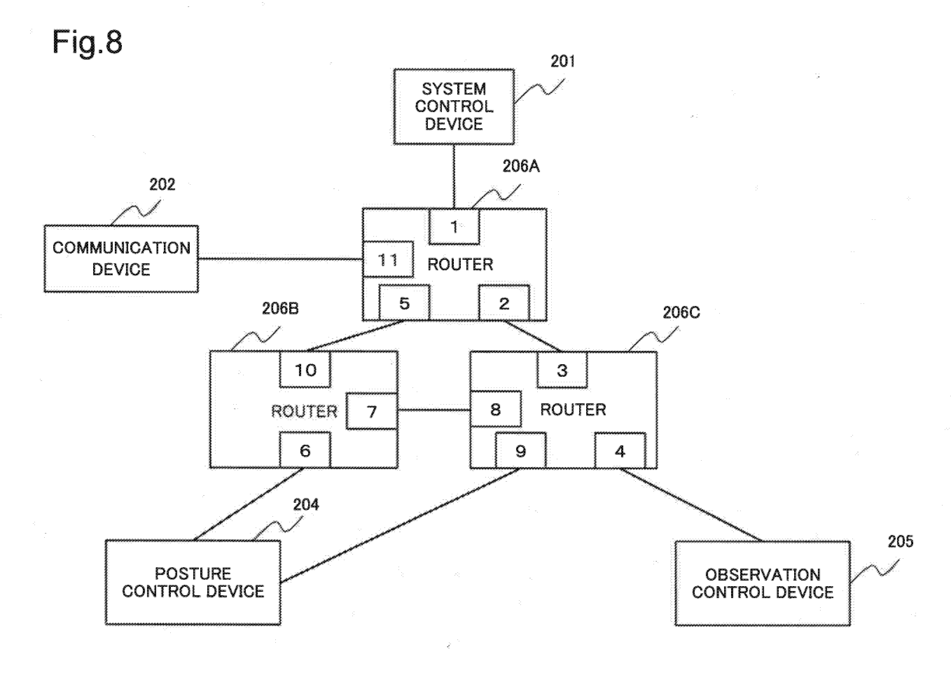

The topology information 101 illustrated in FIG. 5 is information generated based on a path address of a port in the SpaceWire network 200 as illustrated in FIG. 8, for example.

Note that FIG. 8 is a detailed diagram illustrating an example of a path address of a port in a part of the SpaceWire network 200 illustrated in FIG. 1. In FIG. 8, a line between each device and the router 206 indicates a link. Note that in FIG. 8, illustration of a link to an unillustrated device in FIG. 8 is omitted. Further, in FIG. 8, a number written in a box connected to each link of each router 206 denotes a path address of a port. For example, a path address of a port of the router 206A connected to the system control device 201 via a link is “1”.

As illustrated in FIG. 5, the topology information 101 includes information relating to a path address, and information relating to a connection (link). In FIG. 5, a table illustrated in an upper portion is a table of information relating to path addresses. Further, in FIG. 5, a table illustrated in a lower portion is a table of information relating to connections. Further, in each of the tables, each row indicates a set of information.

Information relating to path addresses indicated in the upper portion of FIG. 5 includes device names, path addresses, and transmission delay times.

The device name is information indicating a name of a device associated with a path address. The device name is not limited to a specific name, and may be information for distinguishing a device (e.g. an identifier (ID)).

The path address is a path address for use as a route through which a packet is transmitted to each device. For example, a path address for use when a packet is transmitted to the system control device 201 indicated in the first row of the upper table in FIG. 5 is “1”.

The transmission delay time is a maximum delay time required when a packet passes through a device indicated by a device name.

Further, information relating to connections indicated in the lower portion of FIG. 5 includes connection IDs (link IDs), connection sources, connection destinations, and communication capacities.

The connection ID (link ID) is information for identifying a connection (link).

The connection source and the connection destination are information indicating a name (or an ID) of a device being a connection source, and a name (or an ID) of a device being a connection destination in connection using a link. The connection source and the connection destination are interchangeable. For example, a link having a link ID “1” indicated in the first row of the lower table in FIG. 5 is able to perform both communication i.e. communication from the system control device 201 to the router 206A, and communication from the router 206A to the system control device 201.

The communication capacity is information indicating a communication capacity (communication bandwidth) in the link.

Next, the communication request information 102 is described.

The communication request information 102 is information indicating a test content requested to be performed as a test in a test target (SpaceWire network 200). More specifically, the communication request information 102 is route information associated with communication serving as an object to be tested in a communication target, and detailed information (communication information) relating to communication serving as an object to be tested, such as a type of protocol for use in a test and a data size. Therefore, the communication request information 102 may be generated depending on a test target.

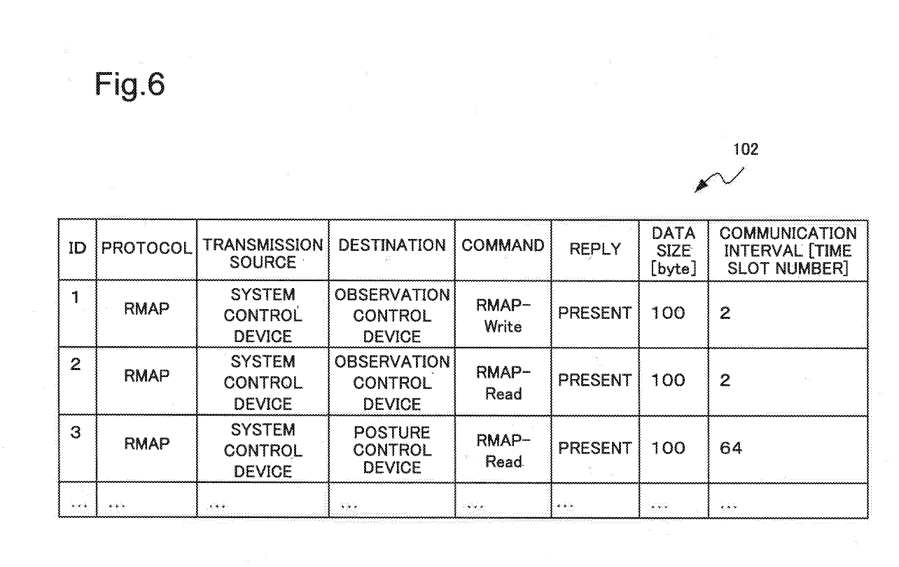

FIG. 6 is a diagram illustrating an example of the communication request information 102 for use in the present description. In FIG. 6, each row is associated with one piece of the communication request information 102. As illustrated in FIG. 6, the communication request information 102 includes an identifier (ID), a protocol, a transmission source, a destination, a command, a response (reply), a data size, and a communication interval.

The ID is an identifier for identifying the communication request information 102.

The protocol is information indicating a protocol for use in the target communication. Note that a remote memory access protocol (RMAP) is a protocol defined with respect to a function of reading and writing data between devices connected to the SpaceWire network 200 (e.g. see NPL 1). In the RMAP, address information of a memory to be accessed in a device being a communication destination is defined. Therefore, the communication request information 102 may include information relating to a memory address to be accessed, in addition to the information illustrated in FIG. 6.

The device names of the transmission source and the destination are device names or identifiers (IDs) of a transmission source (start point) and a destination (end point) in packet communication. Note that as already described, a combination of a device being a transmission source (start point) and a device being a destination (end point) in FIG. 6 is “a requested set of a start point and an end point”.

The command is information indicating a type of information (e.g. a command name) included in a packet to be transmitted. Note that “a command” is used as an item name because there are many commands, as types of information in a test. An item of command in the communication request information 102, however, may include a type of information different from the command, when needed in a test.

The response (reply) is information indicating a presence or an absence of response (reply) with respect to a transmitted packet. A test, in which the column of reply indicates “present”, has a response from a test target. In other words, the test is a test such that a response to the test is included in the test result information 122. On the other hand, a test, in which the column of reply is “no”, does not include a response to the test. In other words, the test is a test such that a response to the test is not included in the test result information 122.

The data size is a data size in a packet for use in a test.

The communication interval indicates the number of time slots for use as a communication interval in packet communication for use in a test.

Note that the communication request information 102 is not necessarily limited to the format illustrated in FIG. 6. For example, a format of the communication request information 102 may be a format of command list being a set of commands with respect to each control device included in the SpaceWire network 200.

Next, the supplementary-setting-table information 112 is described.

The supplementary-setting-table information 112 is information relating to a combination (a set of a communication start point and a communication end point) of a device serving as a transmission source (start point) and a device serving as a destination (an end point or a transmission destination), which are communicable with each other in the SpaceWire network 200.

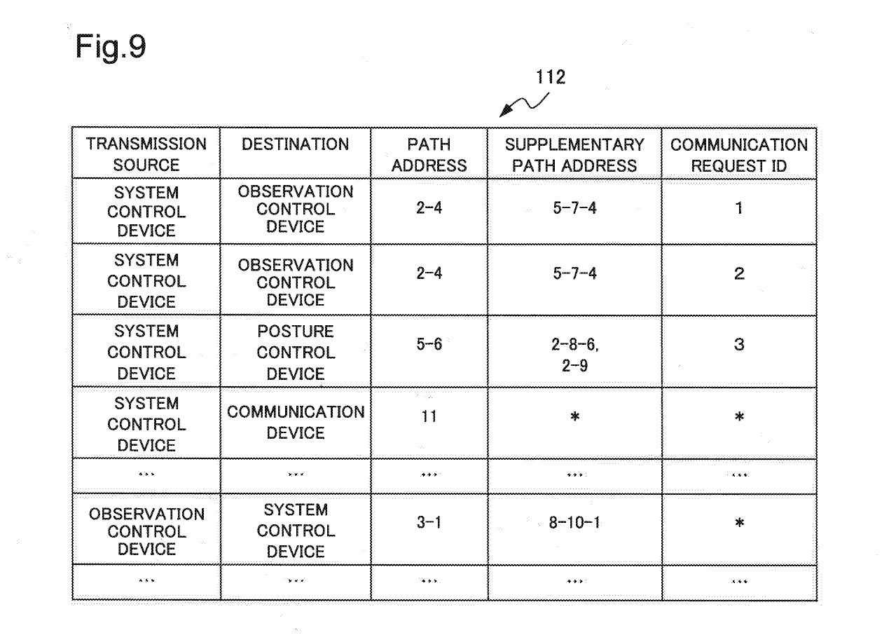

FIG. 9 is a diagram illustrating an example of the supplementary-setting-table information 112 according to the first example embodiment. In FIG. 9, each row is associated with one piece of the supplementary-setting-table information 112. As illustrated in FIG. 9, the supplementary-setting-table information 112 includes transmission sources, destinations, path addresses, supplementary path addresses, and communication request IDs.

The transmission source and the destination are respectively names (or identifiers (IDs)) of a device being a transmission source and a device being a destination.

The path address is a path address of an ordinary route for use in communication from a transmission source to a destination.

The supplementary path address is a path address of a route (bypass route) to be used supplementary when the path address is not used, such as when a failure occurs in the path address.

The communication request ID is an ID of the communication request information 102 associated with a route of the supplementary-setting-table information 112.

Note that in FIG. 9, “*” denotes that there is no data. For example, “*” in the supplementary-setting-table information 112 indicated in the fourth row in FIG. 9 indicates that there is no supplementary path address. Further, the “*” in the supplementary-setting-table information 112 indicates that the supplementary-setting-table information 112 is a route which is not included in the communication request information 102.

Note that the supplementary-setting-table information 112 illustrated in FIG. 9 is generated in such a manner that one ID is included in the communication request ID. The number of the communication request IDs in the supplementary-setting-table information 112, however, is not limited to one, and a plurality of IDs may be included.

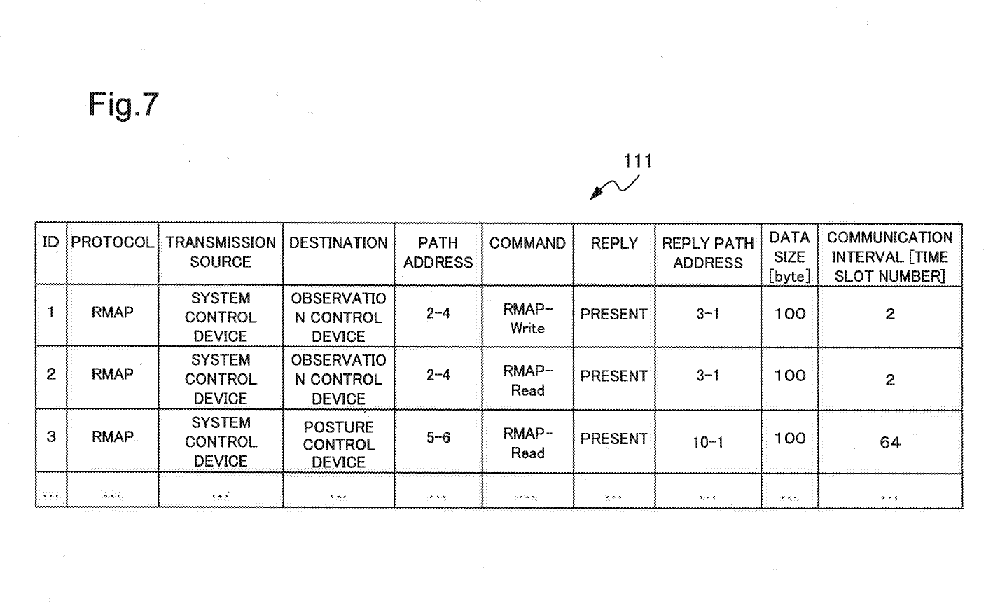

Next, an operation of calculating a path address [2-4] in the first row of the setting table information 111 illustrated in FIG. 7 by the route calculation unit 110 is described.

The route calculation unit 110 extracts, as a set of a communication start point and a communication end point, “the system control device 201 to the observation control device 205”, based on the topology information 101 (e.g. the table in the lower portion of FIG. 5).

In this case, the route calculation unit 110 recognizes that “the system control device 201 being a start point” is connected to “the router 206A”, based on the topology information 101. Likewise, the route calculation unit 110 recognizes that “the observation control device 205 being an end point” is connected to the “router 206C”. Further, the route calculation unit 110 also recognizes that the route in this case is a route from the system control device 201 being a start point to the observation control device 205 being an end point via “the router 206A to the router 206C”.

In other words, the route calculation unit 110 recognizes a path address to be set when a packet is transmitted from the system control device 201 to the observation control device 205. Specifically, the route calculation unit 110 recognizes that a path address of a port of the router 206A to the router 206C and a path address of a port of the router 206C to the observation control device 205 may be set.

Then, the route calculation unit 110 recognizes that a first path address is the path address “2” of the router 206A, and a last path address is the path address “4” of the observation control device, based on the topology information 101.

Consequently, the route calculation unit 110 recognizes that, as a path address, [2-4] being the path address “2” of the router 206A and the path address “4” of the observation control device 205 may be set.

The route calculation unit 110 may calculate other path addresses in the similar manner as described above. For example, in a case of a route including three or more routers 206, the route calculation unit 110 may add a path address of a port (port serving as an exit) of the router 206 being a relay router at a midway of the route, in addition to the aforementioned operation.

In this way, the route calculation unit 110 generates the supplementary-setting-table information 112 associated with path addressing communication, based on the topology information 101.

Next, the setting table information 111 is described.

The setting table information 111 is information for use when the test information generation unit 120 generates the test information 121.

FIG. 7 is a diagram illustrating an example of the setting table information 111 according to the first example embodiment. In FIG. 7, each row indicates one piece of the setting table information 111. As illustrated in FIG. 7, the setting table information 111 is such that path addresses and reply path addresses are added to the communication request information 102 illustrated in FIG. 6. The path address in the setting table information 111 is a path address of a port through which the setting table information 111 passes during transmission. Further, the reply path address is a path address of a port through which a response (reply) in the setting table information 111 passes. The route calculation unit 110 sets a path address and a reply path address with respect to each piece of the communication request information 102 by referring to the aforementioned supplementary-setting-table information 112, and generates the setting table information 111. Note that the route calculation unit 110 may calculate a path address associated with a route, in which a transmission source (start point) and a destination (end point) are interchanged, by referring to the supplementary-setting-table information 112 when a reply path address is set.

Next, the test information generation unit 120 is described with reference to FIG. 3.

The test information generation unit 120 acquires the setting table information 111, and additional test information 131 received from the failure cause identifying unit 130 to be described later. Then, the test information generation unit 120 generates the test information 121 being information to be referred to in a subsystem test in the SpaceWire network 200, based on the setting table information 111 and the additional test information 131. Then, the test information generation unit 120 outputs the generated test information 121 to the SpaceWire network 200 being a test target.

The test information generation unit 120 sets a transmission order included in the test information 121, at least taking into consideration a time slot for use in path addressing communication in a test target. The test information 121 will be described later in detail.

A detailed configuration of the test information generation unit 120 is described with reference to a drawing.

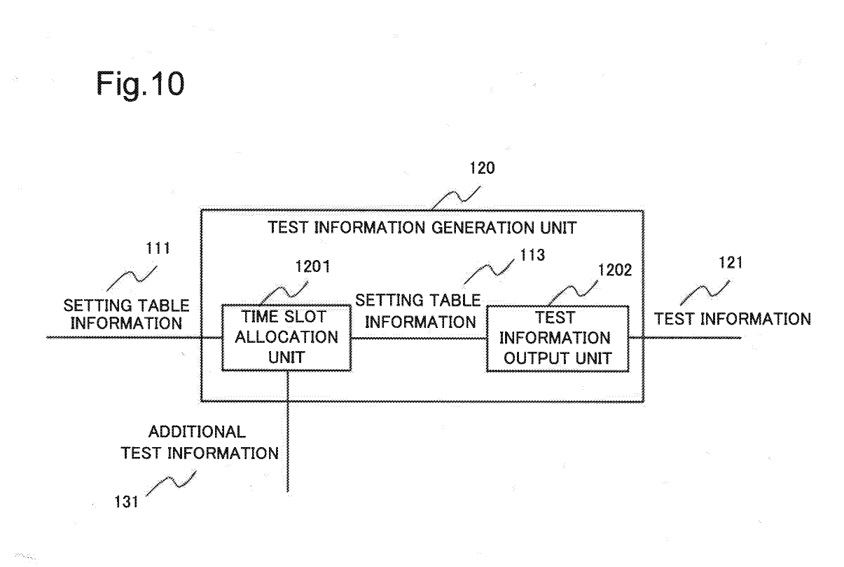

FIG. 10 is a block diagram illustrating an example of a detailed configuration of the test information generation unit 120. As illustrated in FIG. 10, the test information generation unit 120 includes a time slot allocation unit 1201 and a test information output unit 1202.

The time slot allocation unit 1201 allocates (sets) a time slot with respect to each test in such a manner that tests included in the setting table information 111 and the additional test information 131 are appropriately performed in the SpaceWire network 200. In other words, the time slot allocation unit 1201 performs scheduling of the setting table information 111 and the additional test information 131. Herein, scheduling is allocating a time slot with respect to each test in such a manner that the communication interval is satisfied. A method for use in scheduling by the time slot allocation unit 1201 is not specifically limited. For example, the time slot allocation unit 1201 may use the method described in NPL 4.

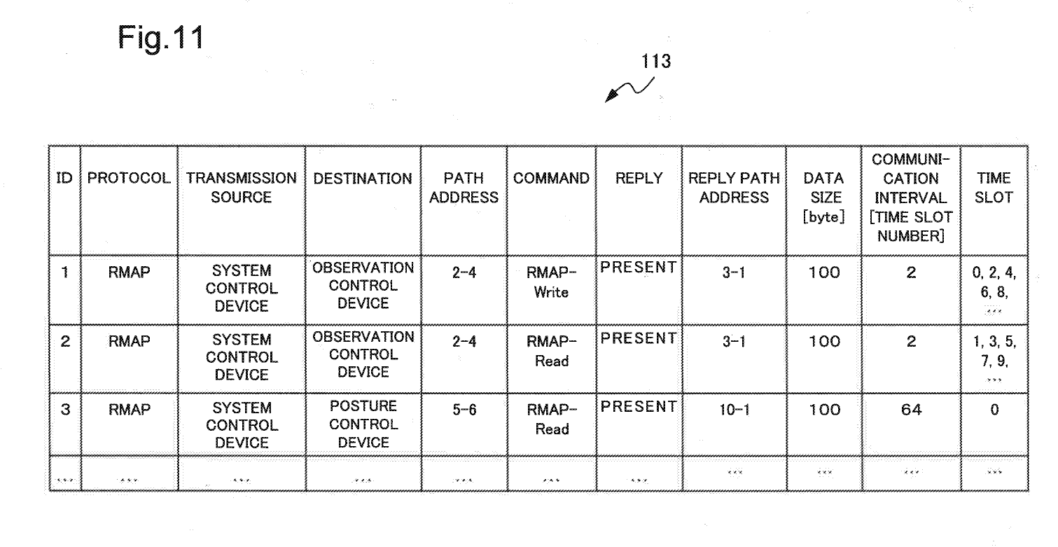

FIG. 11 is a diagram illustrating an example of setting table information 113 in which time slots are allocated. In FIG. 11, each row indicates one piece of the setting table information 113. The setting table information 113 illustrated in FIG. 11 is such that time slots are given to the setting table information 111 illustrated in FIG. 7.

Note that it is possible to transmit a plurality of packets in one time slot. In other words, a plurality of tests may be allocated to a same time slot. For example, same time slots are partially allocated in the first row and in the third row of the setting table information 113. It is, however, desirable to set a less number of packets to be communicated in one time slot. Therefore, the time slot allocation unit 1201 allocates time slots in such a manner that the number of packets allocated to a same time slot is reduced. An example of such a method is described in NPL 4.

Consequently, the time slot allocation unit 1201 allocates, as the setting table information 113 illustrated in FIG. 11, even-numbered time slots to the setting table information 113 where ID=1. Likewise, the time slot allocation unit 1201 allocates odd-numbered time slots to the setting table information 113 where ID=2. Note that this allocation is also an allocation that satisfies a communication interval (number of time slot) in the setting table information 111.

The time slot allocation unit 1201 outputs, to the test information generation unit 120, the setting table information 113 in which time slot are allocated.

The test information output unit 1202 receives the setting table information 113. Then, the test information output unit 1202 converts the setting table information 113 into a format usable in a test in the SpaceWire network 200, and thereby generates the test information 121. Herein, the format includes at least an order (transmission order), in which a packet in a test is transmitted.

Then, the test information output unit 1202 outputs the generated test information 121 to the SpaceWire network 200.

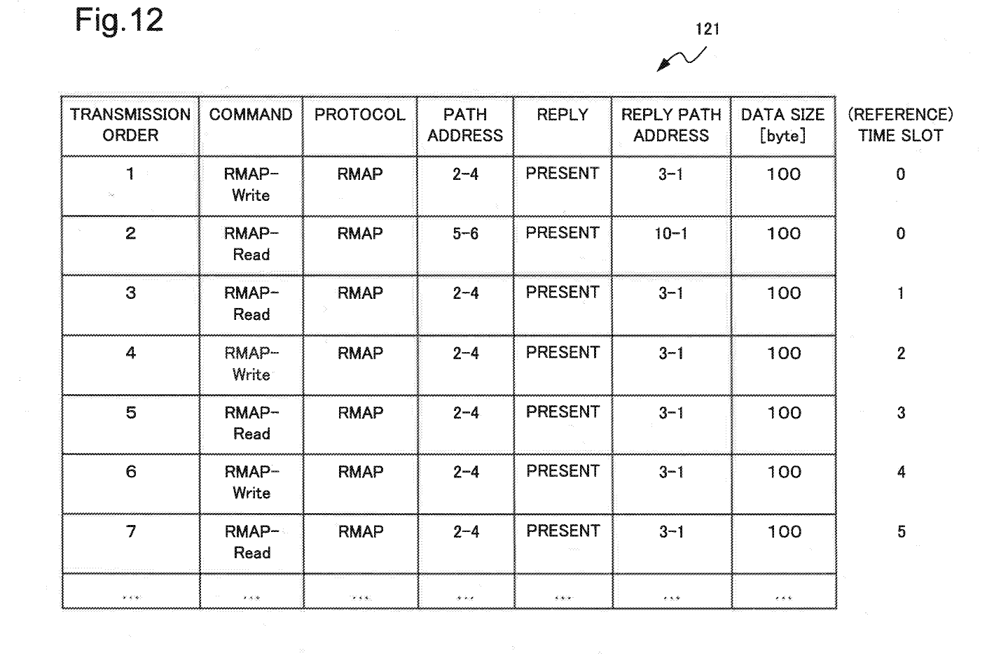

FIG. 12 is a diagram illustrating an example of the test information 121 according to the first example embodiment. In FIG. 12, each row denotes one piece of the test information 121. The test information 121 illustrated in FIG. 12, however, is a diagram for describing an operation of the test information output unit 1202. In other words, a format of the test information 121 to be actually transmitted to the SpaceWire network 200 may be different from the format of the test information 121 illustrated in FIG. 12. Further, FIG. 12 illustrates time slots, as a reference for understanding the test information 121.

Information included in the test information 121 illustrated in FIG. 12 is associated with information included in the setting table information 113 illustrated in FIG. 11, except for a transmission order.

The transmission order is an order (order of communication), in which a packet is transmitted in a test that refers to the test information 121. The test information output unit 1202 generates a transmission order in the test information 121, based on time slots in the setting table information 113, and sets the transmission order in the test information 121.

For example, a time slot “0” is allocated in the first row and in the third row of the setting table information 113 illustrated in FIG. 11. Therefore, the test information output unit 1202 sets, as information on the transmission order 1 of the test information 121, information in the first row of the setting table information 113. Then, the test information output unit 1202 sets, as information on the transmission order 2 of the test information 121, information in the third row of the setting table information 113.

Next, the test information output unit 1202 sets, in the test information 121, the setting table information 113 (in this case, information in the second row) in which “1” is allocated to the time slot of the test information 121 as information on the transmission order 3. Hereinafter, the test information output unit 1202 sets test information in the test information 121 in the similar manner as described above.

Next, the failure cause identifying unit 130 is described with reference to FIG. 3.

The failure cause identifying unit 130 receives the test result information 122 from the SpaceWire network 200. Further, the failure cause identifying unit 130 receives the supplementary-setting-table information 112 from the route calculation unit 110. Further, the failure cause identifying unit 130 receives the topology information 101 from the route calculation unit 110.

Then, the failure cause identifying unit 130 generates the test report information 132 or the additional test information 131, based on the aforementioned information, and outputs the test report information 132 or the additional test information 131.

The test report information 132 is information to be output to a predetermined device, as a test result. The test report information 132 includes information required for a device being an output destination. For example, when the predetermined device is a maintenance device, the test report information 132 includes a content of a test (failure content) indicating a failure, and a candidate of a cause of failure. In this case, the test report information 132 extracts, from the test result information 122 received for the first time, and the test result information 122 in an additional test to be described later, a content of a test indicating a failure, and a candidate of a cause of failure.

The additional test information 131 is information relating to a test to be performed additionally in the SpaceWire network 200 in order to narrow down a cause of failure when failure information is included in the test result information 122. The failure cause identifying unit 130 outputs the additional test information 131 to the test information generation unit 120. The test information generation unit 120 generates the test information 121 for an additional test associated with the additional test information 131, and transmits the test information 121 to the SpaceWire network 200.

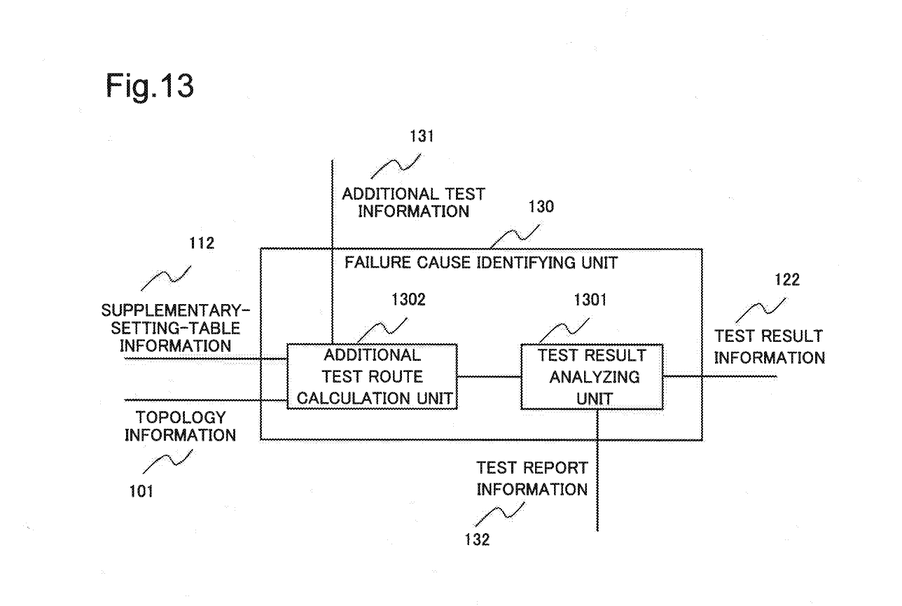

FIG. 13 is a block diagram illustrating an example of a detailed configuration of the failure cause identifying unit 130. As illustrated in FIG. 13, the failure cause identifying unit 130 includes a test result analyzing unit 1301 and an additional test route calculation unit 1302.

The test result analyzing unit 1301 receives the test result information 122 from the SpaceWire network 200.

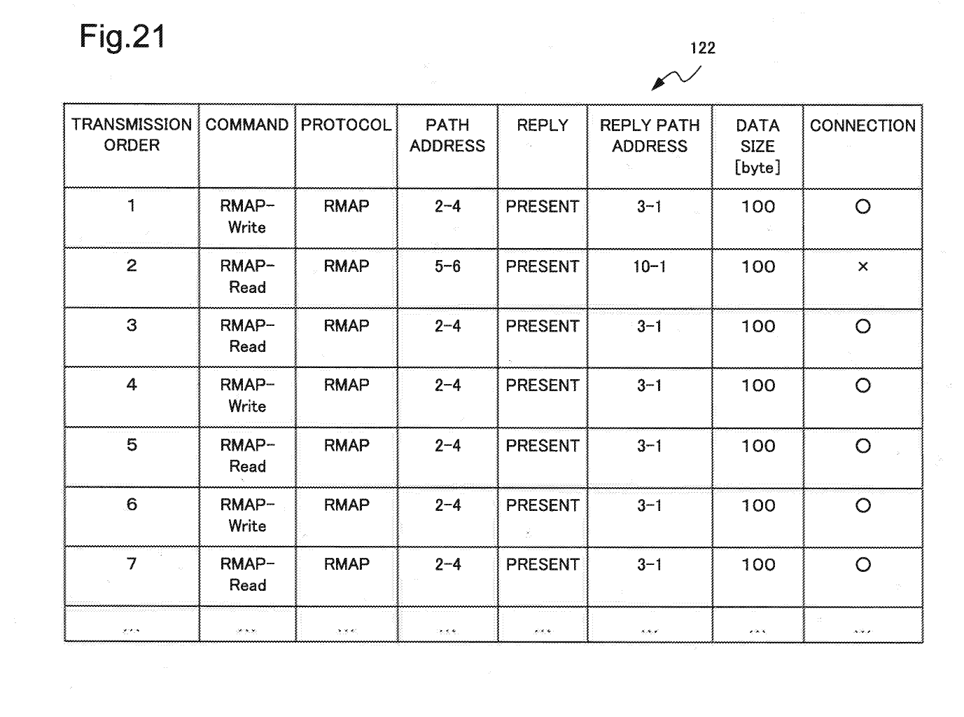

FIG. 21 is a diagram illustrating an example of the test result information 122 according to the first example embodiment. In FIG. 21, each row denotes one piece of the test result information 122. Information included in the test result information 122 is associated with information included in the test information 121 illustrated in FIG. 12, except for connection.

The connection is information indicating whether or not a test is normally finished in a test that refers to the associated test information 121. The expression that a test is normally finished means that communication in a test is normally completed, or communication in a test is passed. Further, the expression that a test is abnormally finished means that communication in a test is not completed (packet non-transmission), or communication in a test is not passed. In the connection illustrated in FIG. 21, ∘ mark denotes connected (normal), and x mark denotes not transmitted (failed). For example, in FIG. 21, the test result information 122 in the second row indicates not transmitted.

The present example embodiment is described referring back to FIG. 13.

When information relating to a failure (column of connection indicates “unable to connect”) is not included in the test result information 122, the test result analyzing unit 1301 generates the test report information 132 being report information with respect to a report destination device on the outside, based on the test result information 122. Then, the test result analyzing unit 1301 outputs the generated test report information 132 to the report destination device. Note that as already described, the test result analyzing unit 1301 may use information and a format in conformity with a report destination device, as information and a format included in the test report information 132.

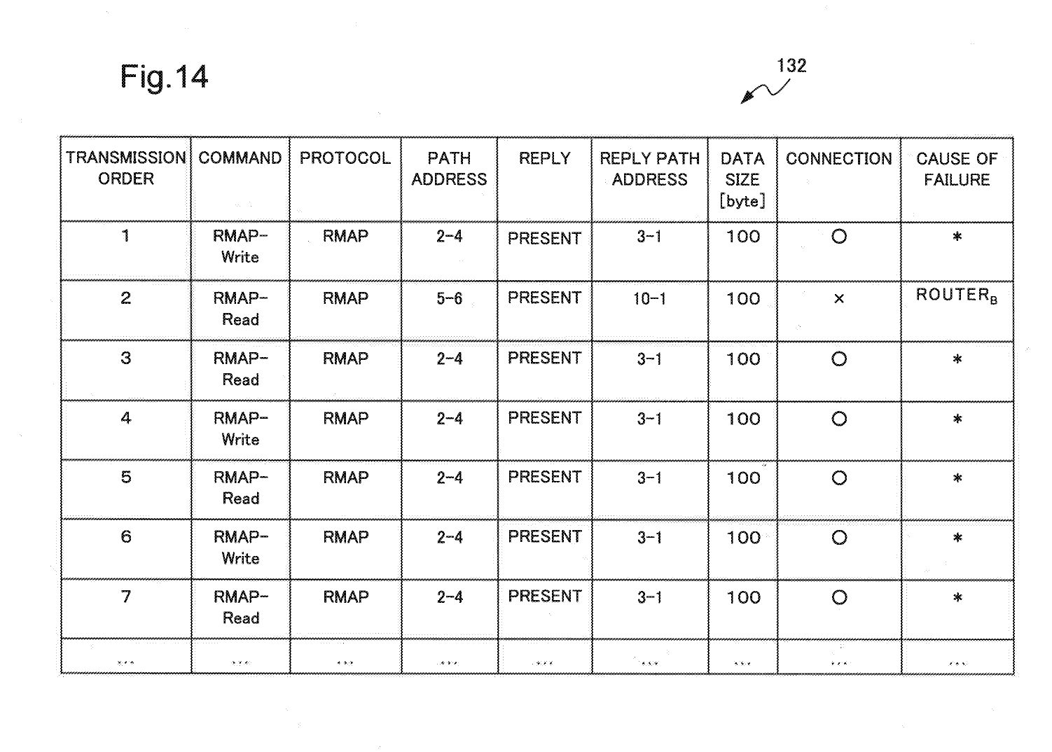

FIG. 14 is a diagram illustrating an example of the test report information 132 according to the first example embodiment. The test report information 132 illustrated in FIG. 14 includes a cause of failure, in addition to the test result information 122 illustrated in FIG. 21. As will be described later, there is a case that the testing device 100 is able to analyze the test result information 122, and the test result information 122 with respect to an additional test, and determine a cause of failure. When the testing device 100 is able to determine a cause of failure, the test result analyzing unit 1301 generates the test report information 132 including a cause of failure in a determined range.

The present example embodiment is described referring back to FIG. 13.

On the other hand, when information relating to a failure is included in the test result information 122, the test result analyzing unit 1301 calculates (extracts) a candidate of a cause of failure, based on the test result information 122. The test result analyzing unit 1301 outputs the extracted information to the additional test route calculation unit 1302.

The additional test route calculation unit 1302 determines whether or not it is possible to perform an additional test for narrowing down a cause of failure by using a result (candidate of a cause of failure) extracted by the test result analyzing unit 1301, the supplementary-setting-table information 112, and the topology information 101. More specifically, the additional test route calculation unit 1302 determines whether or not there is a route (route for an additional test: This is a bypass route) through which a test packet for use in an additional test is transmitted. Herein, the additional test route is, for example, a route using a supplementary path address.

When there is an additional test route, the additional test route calculation unit 1302 generates the additional test information 131 being information for generating the test information 121 to be referred to in an additional test by the test information generation unit 120, based on the additional test route. Then, the additional test route calculation unit 1302 outputs the generated additional test information 131 to the test information generation unit 120. It is desirable that a format of the additional test information 131 is the same as the setting table information 111 or the test information 121. This is for the purpose of reducing a conversion operation in the test information generation unit 120. The additional test information 131, however, may use a format different from the formats of the setting table information 111 and the test information 121. Note that it is desirable that the additional test route calculation unit 1302 notifies the test result analyzing unit 1301 of an output of the additional test information 131 to the test information generation unit 120. This is because the test result analyzing unit 1301 performs processing of waiting receipt of a report that the additional test route calculation unit 1302 is unable to perform an additional test. The test result analyzing unit 1301 is able to finish processing of waiting a notification, based on this notification. Then, the test result analyzing unit 1301 is able to proceed to processing of waiting receipt of a next piece of the test result information 122.

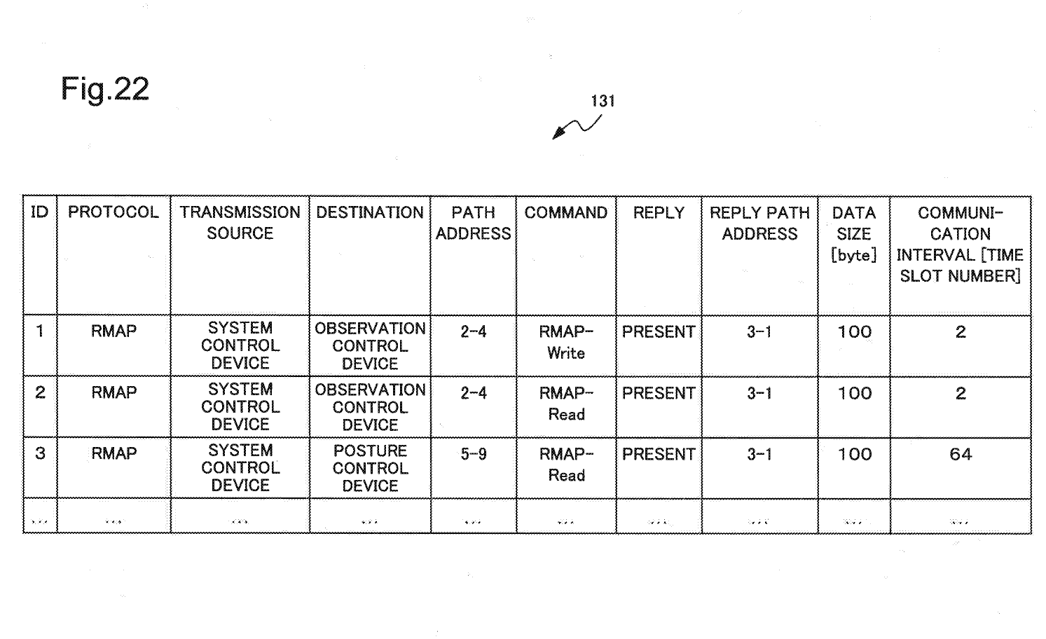

FIG. 22 is a diagram illustrating an example of the additional test information 131 according to the first example embodiment. In FIG. 22, each row denotes one piece of the additional test information 131. The additional test information 131 illustrated in FIG. 22 is additional test information 131 in which the information indicated in the third row is generated. The path address of the additional test information 131 indicated in the third row in FIG. 22 is changed from a path address [5-6] in the third row of the setting table information 111 illustrated in FIG. 7 to a path address [5-9]. In other words, the additional test information 131 illustrated in FIG. 22 indicates that a test using a route of the path address [5-6] in a first test is additionally performed by using the path address [5-9].

In this way, the failure cause identifying unit 130 generates the additional test information 131 associated with path addressing communication, based on the topology information 101.

On the other hand, when there is no additional test route, the additional test route calculation unit 1302 reports (notifies) the test result analyzing unit 1301 that it is not possible to perform an additional test. When this report is received, the test result analyzing unit 1301 generates the test report information 132 based on the test result information 122, and outputs the test report information 132 to a report destination device.

[Description of Operation]

Next, an operation of the testing device 100 according to the first example embodiment is described with reference to a drawing.

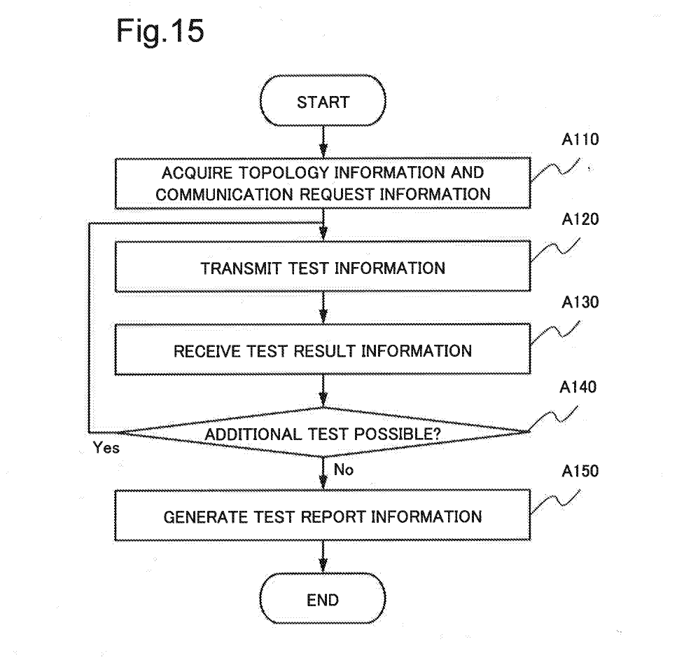

FIG. 15 is a flowchart illustrating an outline of an operation of the testing device 100.

First of all, the testing device 100 acquires the topology information 101 and the communication request information 102 (Step A110).

Next, the testing device 100 generates the test information 121, based on the topology information 101 and the communication request information 102, and outputs the generated test information 121 to the SpaceWire network 200 (Step A120).

Then, the testing device 100 receives, from the SpaceWire network 200, the test result information 122 being a result of a test that refers to the test information 121 (Step A130).

The testing device 100 determines whether or not it is possible to perform an additional test for identifying a cause of failure, based on the received test result information 122 (Step A140).

When it is possible to perform an additional test (Yes in Step A140), the testing device 100 generates the test information 121 associated with an additional test, and the flow returns to Step A120 to transmit the test information 121 to the SpaceWire network 200.

When it is not possible to perform an additional test (No in Step A140), the testing device 100 generates the test report information 132, and outputs the test report information 132 to a predetermined device (Step A150).

Then, the testing device 100 terminates the operation.

Next, an operation of the route calculation unit 110 is described with reference to a drawing.

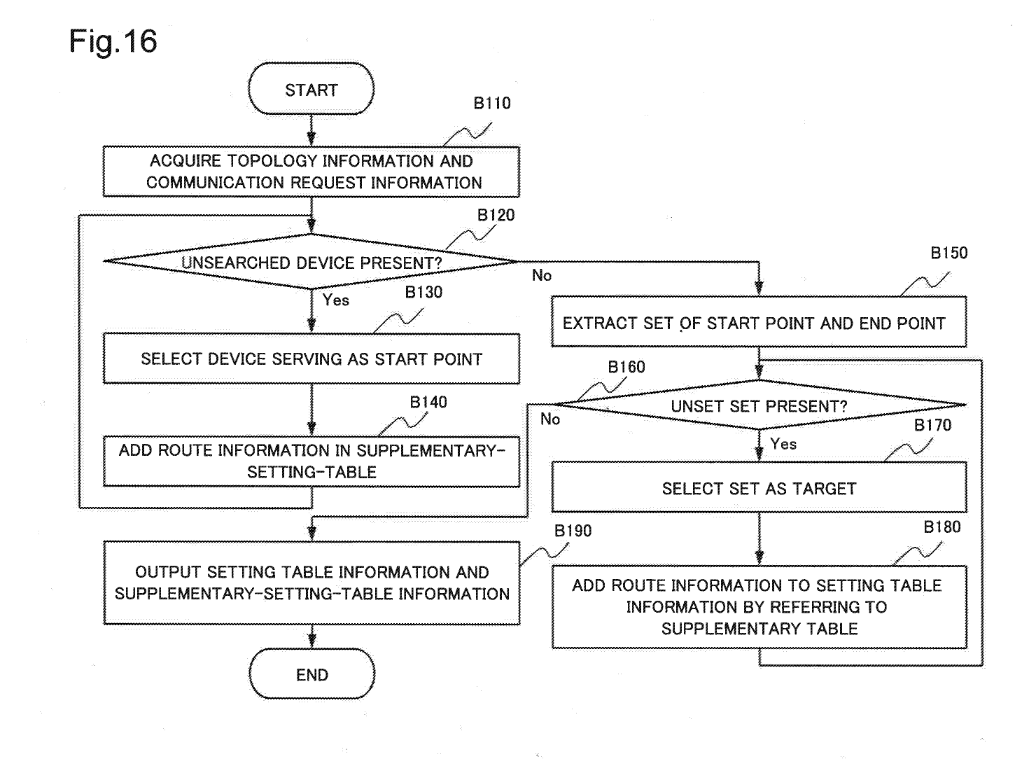

FIG. 16 is a flowchart illustrating an example of an operation of the route calculation unit 110 according to the first example embodiment.

First of all, the route calculation unit 110 acquires the topology information 101 and the communication request information 102 (Step B110).

The route calculation unit 110 initializes the supplementary-setting-table information 112, or newly generates the supplementary-setting-table information 112.

Then, the route calculation unit 110 extracts all combinations (sets of communication start points and communication end points) of devices serving as communication start points and devices serving as communication end points included in the SpaceWire network 200, based on the topology information 101.

Then, the route calculation unit 110 determines whether or not there is a device serving as a start point, for which a route is not yet searched (Step B120).

When there is a device serving as a start point (Yes in Step B120), the route calculation unit 110 selects a device serving as one start point from among devices serving as start points, as a search target in a route (Step B130).

Next, the route calculation unit 110 searches a route (route information) relating to all sets of communication start points and communication end points having the selected device as a start point, based on the topology information 101. Then, the route calculation unit 110 adds route information relating to the searched sets of communication start points and communication end points to the supplementary-setting-table information 112 (Step B140). Note that the SpaceWire network 200 uses path addressing communication (source routing method). Therefore, the route calculation unit 110 generates route information associated with path addressing communication, as route information. Note that a route connecting a device being a start point and a device being an end point is not limited to one, and a plurality of routes may be present. In such a case, the route calculation unit 110 adds, to the supplementary-setting-table information 112, all pieces of searched route information including a bypass route, based on a predetermined rule (e.g. a rule such that a route is registered from a route having a less number of devices through which a packet is passed).

The route calculation unit 110 repeats the operations from Step B130 to Step B140 until there is no device serving as an unsearched start point.

Note that the topology information 101 is not limited to the information illustrated in FIG. 5. For example, the topology information 101 may include information relating to a route associated with a set of a communication start point and a communication end point, which is calculated based on the aforementioned operation. In this case, the route calculation unit 110 may omit the operations from Step B120 to Step B140. Then, the route calculation unit 110 may use the topology information 101, in place of the supplementary-setting-table information 112 in the following operation.

When there is no device serving as an unsearched start point (No in Step B120), the route calculation unit 110 generates the setting table information 111, based on the communication request information 102 and the supplementary-setting-table information 112. As already described, the setting table information 111 includes route information (a path address and a reply path address), in addition to information included in the communication request information 102. Therefore, as will be described in the following, the route calculation unit 110 generates route information to be added to the setting table information 111, and adds the route information to the setting table information 111.

First of all, the route calculation unit 110 replicates information of the communication request information 102 in the setting table information 111.

Then, the route calculation unit 110 extracts all sets (sets of communication start points and communication end points) of devices (transmission sources) serving as start points and devices (destinations) serving as end points included in the setting table information 111 or in the communication request information 102 (Step B150).

Then, the route calculation unit 110 determines whether or not there is a requested set of a start point and an end point, for which route information is not set in the setting table information 111 (Step B160).

When there is a requested set of a start point and an end point (unsearched set), for which route information is not set (Yes in Step B160), the route calculation unit 110 selects a requested set of a start point and an end point, for which a route is set (Step B170).

Then, the route calculation unit 110 adds (sets), to the setting table information 111, route information associated with the requested set of a start point and an end point, based on the supplementary-setting-table information 112 (Step B180). Note that when there are a plurality of pieces of route information, the route calculation unit 110 selects and adds a route to be added, based on a predetermined rule (e.g. a shortest route).

Further, the route calculation unit 110 adds an identifier (ID) of a requested set of a start point and an end point, to a communication request ID of the supplementary-setting-table information 112 associated with a requested set of a start point and an end point included in the communication request information 102 (or the setting table information 111) to which route information is added. The communication request ID is information that associates a test included in the communication request information 102, a path address relating to a route for use in the test, and a path address of a bypass route associated with the route. For example, the failure cause identifying unit 130 may refer to a communication request ID when an operation of calculating a route (bypass route) of an additional test is performed.

The route calculation unit 110 repeats the operations from Step B170 to Step B180 until there is no requested set (unsearched set) of a start point and an end point, for which a route is not set.

When there is no unsearched requested set of a start point and an end point (No in Step B160), the route calculation unit 110 outputs the setting table information 111 to the test information generation unit 120, and outputs the supplementary-setting-table information 112 and the topology information 101 to the failure cause identifying unit 130 (Step B190).

Then, the route calculation unit 110 terminates the operation.

Next, an operation of the test information generation unit 120 is described with reference to a drawing.

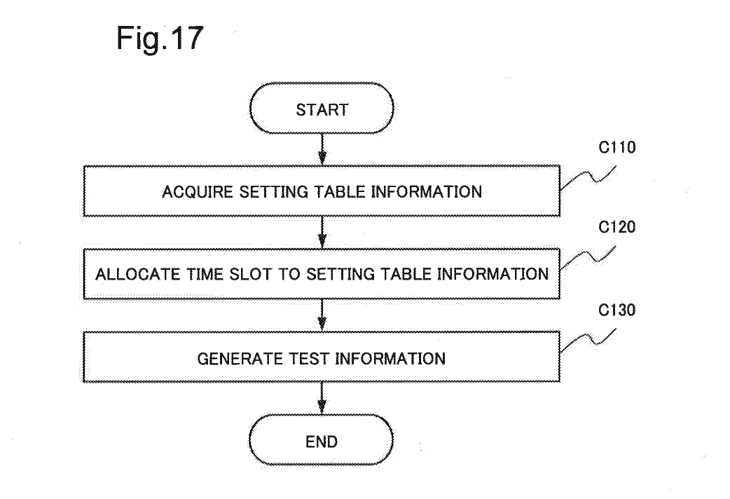

FIG. 17 is a flowchart illustrating an example of an operation of the test information generation unit 120 according to the first example embodiment.

The time slot allocation unit 1201 of the test information generation unit 120 receives the setting table information 111 or the additional test information 131 (Step C110). Note that the operation with respect to the additional test information 131 is the same as the operation with respect to the setting table information 111. Therefore, the following description is made by using the setting table information 111 in order to clarify the description. In the following description, when the additional test information 131 is received, the test information generation unit 120 may use the additional test information 131, in place of the setting table information 111.

The time slot allocation unit 1201 performs time scheduling of the setting table information 111 (Step C120). In other words, the time slot allocation unit 1201 generates the setting table information 113, in which a time slot is allocated to the setting table information 111.

Next, the test information output unit 1202 generates the test information 121 to be referred to in the SpaceWire network 200, based on the setting table information 113 (Step C130). Then, the test information output unit 1202 transmits the test information 121 to the SpaceWire network 200.

Next, a detailed operation of the time slot allocation unit 1201 is described with reference to a drawing.

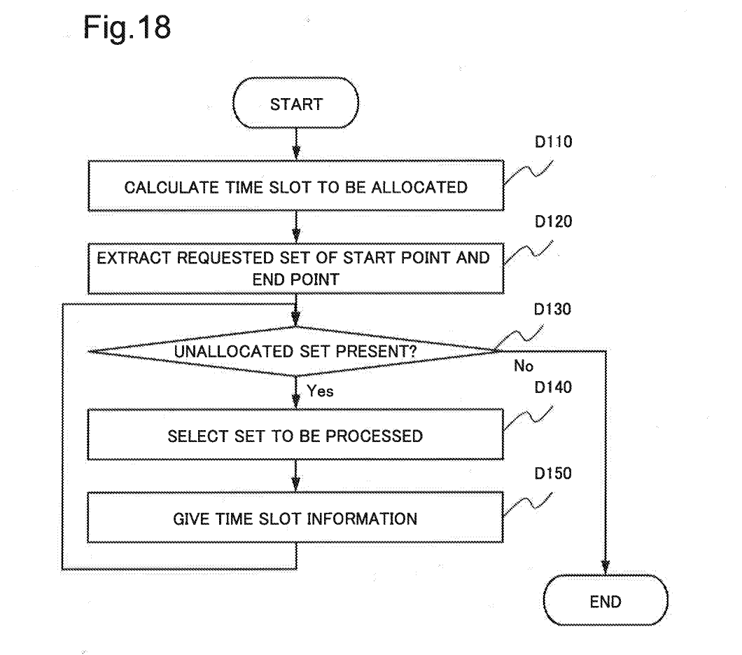

FIG. 18 is a flowchart illustrating an example of an operation of the time slot allocation unit 1201 according to the first example embodiment.

First of all, the time slot allocation unit 1201 acquires the setting table information 111, and calculates a time slot to be allocated, based on the setting table information 111 (Step D110). In other words, the time slot allocation unit 1201 determines a time slot to be specifically allocated with respect to the setting table information 111. An allocation method used by the time slot allocation unit 1201 is not specifically limited. For example, the time slot allocation unit 1201 may use a method described in NPL 4, as a method used in allocation.

Next, the time slot allocation unit 1201 extracts a requested set of a start point and an end point, based on the setting table information 111 (Step D120).

Next, the time slot allocation unit 1201 determines whether or not there is a requested set of a start point and an end point, for which a time slot is not allocated (Step D130).

When there is a requested set of a start point and an end point, for which a time slot is not allocated (Yes in Step D130), the time slot allocation unit 1201 selects one from among the requested sets of start points and end points, for which a time slot is not allocated (D140).

Then, the time slot allocation unit 1201 allocates (gives) a calculated time slot to the selected requested set of a start point and an end point (Step D150). Specifically, the time slot allocation unit 1201 gives a time slot to the setting table information 111 illustrated in FIG. 7, and generates the setting table information 113 illustrated in FIG. 11.

The time slot allocation unit 1201 repeats the operations of Step D140 and Step D150 until there is no requested set of a start point and an end point, for which a time slot is not allocated.

When there is no requested set of a start point and an end point, for which a time slot is not allocated (No in Step D130), the time slot allocation unit 1201 terminates the operation.

Next, an operation of the test information output unit 1202 is described with reference to a drawing.

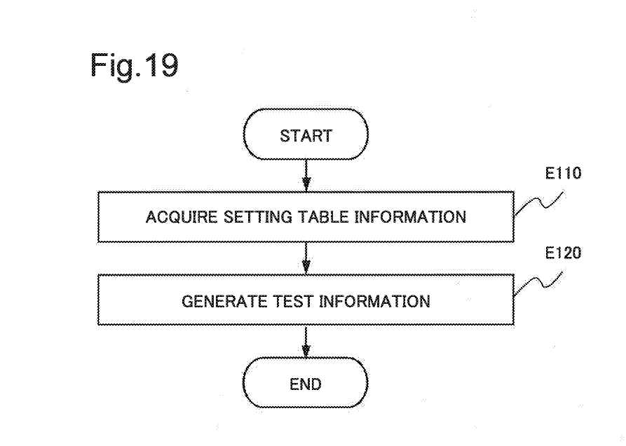

FIG. 19 is a flowchart illustrating an example of an operation of the test information output unit 1202 according to the first example embodiment.

First of all, the test information output unit 1202 receives the setting table information 113 from the time slot allocation unit 1201 (Step E110).

Then, the test information output unit 1202 determines a transmission order in such a manner as to keep a time slot in the setting table information 113, and generates the test information 121 based on the determined transmission order (Step E120). The test information output unit 1202 transmits the generated test information 121 to the SpaceWire network 200.

Next, an operation of the failure cause identifying unit 130 is described with reference to a drawing.

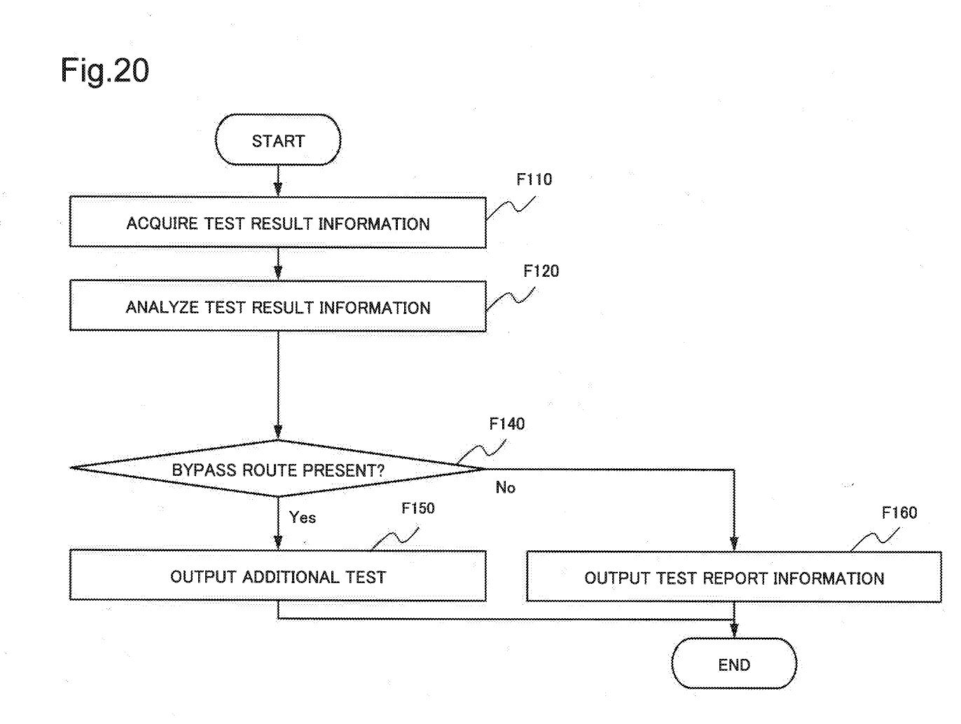

FIG. 20 is a flowchart illustrating an example of an operation of the failure cause identifying unit 130 according to the first example embodiment.

First of all, the test result analyzing unit 1301 of the failure cause identifying unit 130 acquires the test result information 122 from the SpaceWire network 200 (Step F110).

Next, the test result analyzing unit 1301 analyzes whether or not there is a failure in the test result information 122 (Step F120). In this analysis, the test result analyzing unit 1301 identifies (narrows down) a device and a link serving as a candidate of a cause of failure. The test result analyzing unit 1301 uses the topology information 101 or the supplementary-setting-table information 112 to identify a device and a link.

An operation of the test result analyzing unit 1301 is described with reference to the test result information 122 illustrated in FIG. 21.

In the test result information 122 illustrated in FIG. 21, the test result information 122 indicating a failure (not transmitted) is the test result information 122 in the second row where “transmission order=2”. Further, a communication route included in the test result information 122 indicating a failure is a route having a path address [5-6] and a reply path address [10-1]. Therefore, the test result analyzing unit 1301 identifies a device and a link constituting the aforementioned path addresses by using the topology information 101. For example, in the case of the SpaceWire network 200 illustrated in FIG. 8, the test result analyzing unit 1301 extracts, as devices determined to be a cause of failure, the system control device 201, the router 206A, the router 206B, and the posture control device 204. The devices extracted herein serve as candidates of a cause of failure.

Further, the test result information 122 in the first row of FIG. 21 where the transmission order=1 indicates normal (connected). A communication route included in this test result information 122 is a route having a path address [2-4] and a reply path address [3-1]. Therefore, the test result analyzing unit 1301 identifies a device and a link constituting the aforementioned path addresses by using the topology information 101. For example, in the case of the SpaceWire network 200 illustrated in FIG. 8, the test result analyzing unit 1301 extracts, as devices associated with the aforementioned route, the system control device 201, the router 206A, the router 206C, and the observation control device 205. The devices extracted herein are devices being normally operated.

Thus, the test result analyzing unit 1301 is able to narrow down that candidate devices being a cause of failure (non-transmission) in the test result information 122 where the transmission order=2 are the router 206B and the posture control device 204.

Consequently, the test result analyzing unit 1301 is able to specify that candidates of a cause of failure (not transmitted) are the router 206B, the posture control device 204, a link between the router 206A and the router 206B, and a link between the router 206B and the posture control device 204. Likewise, the test result analyzing unit 1301 is able to identify a device and a link serving as a cause of failure (not transmitted), based on all pieces of the test result information 122.

Next, the additional test route calculation unit 1302 determines whether or not there is a route (bypass route) for an additional test to be performed in order to narrow down a candidate of an identified cause of failure by referring to the supplementary-setting-table information 112 (Step F140). The additional test route calculation unit 1302 determines, in the supplementary-setting-table information 112, whether or not there is a bypass route associated with a path address or a reply path address serving as a failure in the test result information 122. Note that the additional test route calculation unit 1302 may use a communication request ID in the supplementary-setting-table information 112 when a bypass route is determined.

The bypass route herein is a route that bypasses a candidate of a certain cause of failure, and is a route for use in an additional test for narrowing down a cause of failure. Therefore, the bypass route is referred to as “an additional test route”.

For example, when candidate devices being a cause of failure as already described are the router 206B and the posture control device 204 illustrated in FIG. 8, the additional test route calculation unit 1302 extracts a path address [2-9] as one of bypass routes. A reply path address associated with this bypass route is [3-1].

This bypass route is a route that bypasses the router 206B. When this route is operated, a candidate device being a cause of failure is the router 206B, a link between the router 206A and the router 206B, or a link between the router 206B and the posture control device 204. On the other hand, when this route is a failure (not transmitted), a candidate of a cause of failure is narrowed down to the posture control device 204.

Note that in this case, there are a path address [2-8-6] and a path address [5-7-9] as other bypass routes.

Then, when a bypass route is extracted (Yes in Step F140), the additional test route calculation unit 1302 generates the additional test information 131 using the extracted route, and outputs the additional test information 131 to the test information generation unit 120 (Step F150). The additional test route calculation unit 1302 may generate the additional test information 131, based on the test result information 122.

For example, the additional test route calculation unit 1302 deletes non-transmitted data from the test result information 122 in the second row illustrated in FIG. 21. Then, the additional test route calculation unit 1302 may replace the path address and the reply path address by the extracted path address and the extracted reply path address, and may generate the additional test information 131. Alternatively, the additional test route calculation unit 1302 may acquire the setting table information 111 from the route calculation unit 110, and may replace the path address and the reply path address in the setting table information 111 by the extracted path address and the extracted replay path address.

When it is not possible to extract a bypass route (No in Step F140), the additional test route calculation unit 1302 reports (notifies) the test result analyzing unit 1301 that it is not possible to perform an additional test. The test result analyzing unit 1301 generates the test information 132, based on this report, and outputs the test information 132 to a predetermined device (Step F160).

### Description of Advantageous Effects

Next, advantageous effects of the first example embodiment are described.

The testing device 100 according to the first example embodiment is able to provide advantageous effects that occurrence of a human error is prevented, and information for appropriately performing a test and an additional test associated with path addressing communication is generated.

The reason for this is as follows.

First of all, as already described, the testing device 100 is able to generate the test information 121 being information to be referred to in a test, based on the topology information 101 and the communication request information 102 without manpower. More specifically, the route calculation unit 110 of the testing device 100 generates the setting table information 111 and the supplementary-setting-table information 112 associated with path addressing communication, based on the topology information 101 and the communication request information 102. Then, the test information generation unit 120 generates the test information 121, based on the setting table information 111 associated with path addressing communication. Further, the failure cause identifying unit 130 generates the additional test information 131 associated with path addressing communication, based on the topology information 101 and the supplementary-setting-table information 112. Then, the test information generation unit 120 generates the test information 121 relating to an additional test, based on the additional test information 131. In this way, the testing device 100 generates information relating to a test associated with path addressing communication without manpower. Thus, the testing device 100 is able to prevent a human error.

Further, the testing device 100 is able to provide an advantageous effect that information for performing an appropriate test in a test target (SpaceWire network 200) is generated.

The reason for this is that, first of all, the test information generation unit 120 generates the test information 121, taking into consideration a time slot in path addressing communication, based on the setting table information 111 generated by the route calculation unit 110.

Further, the testing device 100 is able to provide an advantageous effect that information for performing an appropriate additional test in a test target (SpaceWire network 200) is generated.

The reason for this is that the test information generation unit 120 generates the test information 121, taking into consideration a time slot in path addressing communication for an additional test, based on the additional test information 131 generated by the failure cause identifying unit 130.

Further, the test information generation unit 120 allocates a time slot for use in a test in such a manner that the number of packets to be allocated to one time slot is reduced, as far as a requested communication interval is satisfied. Therefore, by using the test information 121 generated by the testing device 100, it is possible to perform a test having a low load in the SpaceWire network 200 being a test target. When a load in a test is high, a failure in the test may occur, based on a cause other than a cause of failure of a device included in the SpaceWire network 200 (e.g. congestion). However, as described above, since the test information 121 to be generated by the testing device 100 according to the present example embodiment is generated in such a manner that the load is reduced, it is highly likely that a failure occurring in a test is based on a device or a link included in the SpaceWire network 200. Thus, the testing device 100 is able to generate the test information 121 appropriate for a test target.

Further, the testing device 100 is able to provide an advantageous effect that it is easy to identify a cause of failure in a test.

The reason for this is that the failure cause identifying unit 130 extracts a bypass route for narrowing down a cause of failure, based on the test result information 122, and generates the additional test information 131 relating to the bypass route. Further, the test information generation unit 120 generates the test information 121 for narrowing down a cause of failure, based on the additional test information 131, and an additional test is performed with respect to the SpaceWire network 200.

### Modification Example

The testing device 100 as described above may be configured as follows.

For example, each component unit of the testing device 100 may be configured by a hardware circuit.

Further, in the testing device 100, each component unit may be configured by using a plurality of devices connected via a network.

Further, in the testing device 100, a plurality of component units may be constituted by one hardware.

Further, the testing device 100 may be implemented as a computer device including a central processing unit (CPU), a read only memory (ROM), and a random access memory (RAM). The testing device 100 may be implemented as a computer device further including an input and/or output circuit (IOC) and a network interface circuit (NIC), in addition to the aforementioned configuration.

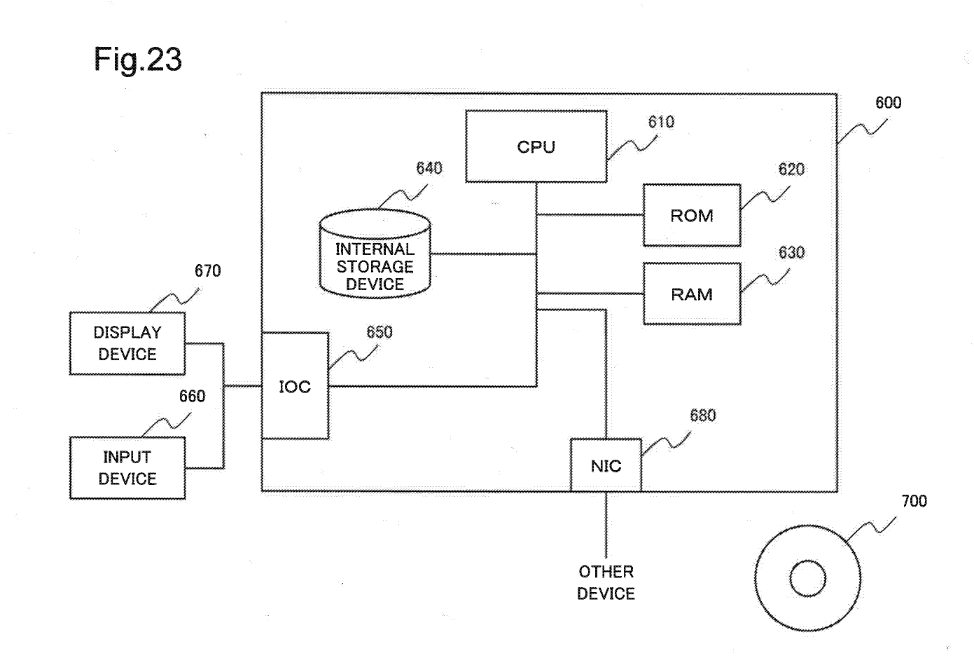

FIG. 23 is a block diagram illustrating an example of a configuration of a testing device 600 according to the present modification example.

The testing device 600 includes a CPU 610, an ROM 620, an RAM 630, an internal storage device 640, an ICO 650, and an NIC 680, and constitutes a computer device.

The CPU 610 reads a program from the ROM 620. Then, the CPU 610 controls the RAM 630, the internal storage device 640, the IOC 650, and the NIC 680, based on the read program. Then, a computer including the CPU 610 controls these components, and implements respective functions as the route calculation unit 110, the test information generation unit 120, and the failure cause identifying unit 130 illustrated in FIG. 3.

The CPU 610 may use the RAM 630 or the internal storage device 640 as a temporary storage of a program when each function is implemented.

Further, the CPU 610 may read a program included in a storage medium 700 storing a computer-readable program by using an unillustrated storage-medium reading device. Alternatively, the CPU 610 may receive a program from an unillustrated external device via the NIC 680, may store the program in the RAM 630, and may be operated based on a stored program.

The ROM 620 stores a program to be executed by the CPU 610 and fixed data. The ROM 620 is, for example, a programmable-ROM (P-ROM) or a flash ROM.

The RAM 630 temporarily stores a program to be executed by the CPU 610 and data. The RAM 630 is, for example, a dynamic RAM (D-RAM).

The internal storage device 640 stores data and a program to be stored in the testing device 600 for a long term. Further, the internal storage device 640 may be operated as a temporary storage device of the CPU 610. The internal storage device 640 is, for example, a hard disk device, a magneto-optical disk device, a solid state drive (SSD), or a disk array device.

Herein, the ROM 620 and the internal storage device 640 are non-transitory storage media. On the other hand, the RAM 630 is a transitory storage medium. Further, the CPU 610 is operable based on a program stored in the ROM 620, the internal storage device 640 or in the RAM 630. In other words, the CPU 610 is operable by using a non-transitory storage medium or a transitory storage medium.

The IOC 650 mediates data between the CPU 610, and an input device 660 and a display device 670. The IOC 650 is, for example, an IO interface card or a universal serial bus (USB) card.

The input device 660 is a device for receiving an input command from an operator of the testing device 600. The input device 660 is, for example, a keyboard, a mouse, or a touch panel. Note that the input device 660 may be operated as an input device. In other words, the input device 660 may receive input of the topology information 101 and the communication request information 102.

The display device 670 is a device for displaying information to an operator of the testing device 600. The display device 670 is, for example, a liquid crystal display. Note that the display device 670 may display the test report information 132.

The NIC 680 relays data communication with an unillustrated external device via a network. The NIC 680 mediates communication with the SpaceWire network 200. The NIC 680 is, for example, a local area network (LAN) card.

The testing device 600 configured as described above is able to provide same advantageous effects as the testing device 100.

The reason for this is that the CPU 610 of the testing device 600 is able to implement same functions as the testing device 100, based on a program.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2005-179156, filed on Sep. 11, 2015, the disclosure of which is incorporated herein in its entirety by reference.

### INDUSTRIAL APPLICABILITY

The present invention is applicable to connection and an operation test of an inter satellite network including an interface in conformity with the SpaceWire specification. The present invention is applicable to a subsystem test (test of each module) in an inter satellite network, and a system test (integration test) before final shipment. Further, the present invention is applicable to a test of a device included in a network using path addressing communication (source routing method).

### REFERENCE SIGNS LIST

100 Testing device
101 Topology information
102 Communication request information
110 Route calculation unit
111 Setting table information
112 Supplementary-setting-table information
113 Setting table information
120 Test information generation unit
121 Test information
122 Test result information
130 Failure cause identifying unit
131 Additional test information
132 Test report information
200 SpaceWire network
201 System control device
202 Communication device
203 Power supply device
204 Posture control device
205 Observation control device
206 Router
210 Mounted device
214 Posture device
215 Observation device
220 Control device simulator
230 Satellite-mounted device group
600 Testing device
610 CPU
620 ROM
630 RAM
640 Internal storage device
650 IOC
660 Input device
670 Display device
680 NIC
700 Storage medium
1201 Time slot allocation unit
1202 Test information output unit
1301 Test result analyzing unit
1302 Additional test route calculation unit

What is claimed is:

1. A testing device comprising:
a route calculator that generates
supplementary-setting-table information including information relating to a route with respect to a set of a communication start point and a communication end point, the set being a combination of a device serving as a communication start point and a device serving as a communication end point that are included in a test target, based on topology information including information indicating a connection relationship between devices included in the test target for performing path addressing communication, and
setting table information being information such that, to a communication request information including information indicating a content of the test in the test target, information relating to a route with respect to a requested set of a start point and an end point, the requested set being a combination of a device serving as a start point and a device serving as an end point of a test included in the communication request information is added, based on the supplementary-setting-table information;
a test information generator that generates test information being information to be referred to in the test in the test target, based on the setting table information and additional test information, by taking into consideration a time slot in the path addressing communication, and
transmits the test information to the test target; and
a failure cause, identifier that receives, from the test target, test result information being a result of the test acquired by referring to the test information, and
generates the additional test information being information for use when the test information generator generates test information to be referred to in an additional test in the test target, based on the test result information, the supplementary-setting-table information, and the topology information.

2. The testing device according to claim 1, wherein
the route calculator
registers all routes with respect to each set of the communication start point and the communication end point into the supplementary-setting-table information.

3. The testing device according to claim 1, wherein
the communication request information includes a communication interval in each of the tests, and
the test information generator
allocates a time slot in each of the tests, based on the communication interval, and
sets a communication order of the test included in the test information, based on the allocated time slot.

4. The testing device according to claim 1, wherein
the failure cause identifier
determines whether or not there is a bypass route being a route for use in an additional test for narrowing down a cause of failure included in the test result information, and
when the bypass route is present, generates the additional test information using the bypass route, and outputs the additional test information to the test information generator.

5. The testing device according to claim 4, wherein
the failure cause identifier
generates and outputs, when the bypass route is not present, test report information being information for use when a result of the test in the test target is reported, based on a result of the test.

6. A testing method comprising:
generating
supplementary-setting-table information including information relating to a route with respect to a set of a communication start point and a communication end point, the set being a combination of a device serving as a communication start point and a device serving as a communication end point that are included in a test target, based on topology information including information indicating a connection relationship between devices included in the test target for performing path addressing communication, and
setting table information being information such that, to a communication request information including information indicating a content of the test in the test target, information relating to a route with respect to a requested set of a start point and an end point, the requested set being a combination of a device serving as a start point and a device serving as an end point of a test included in the communication request information is added, based on the supplementary-setting-table information;
generating test information being information to be referred to in the test in the test target, based on the setting table information and additional test information, by taking into consideration a time slot in the path addressing communication;
transmitting the test information to the test target;
receiving, from the test target, test result information being a result of the test acquired by referring to the test information; and
generating the additional test information being information for use when test information to be referred to in an additional test in the test target is generated, based on the test result information, the supplementary-setting-table information, and the topology information.

7. A non-transitory computer-readable recording medium embodying a program, the program causes a computer to perform a method, the method comprising:
generating
supplementary-setting-table information including information relating to a route with respect to a set of a communication start point and a communication end point, the set being a combination of a device serving as a communication start point and a device serving as a communication end point that are included in a test target, based on topology information including information indicating a connection relationship between devices included in the test target for performing path addressing communication, and
setting table information being information such that, to a communication request information including information indicating a content of the test in the test target, information relating to a route with respect to a requested set of a start point and an end point, the requested set being a combination of a device serving as a start point and a device serving as an end point of a test included in the communication request information is added, based on the supplementary-setting-table information;
generating test information being information to be referred to in the test in the test target, based on the setting table information and additional test information, by taking into consideration a time slot in path addressing communication;
transmitting the test information to the test target;
receiving, from the test target, test result information being a result of the test acquired by referring to the test information; and generating the additional test information being information for use when test information to be referred to in an additional test in the test target is generated, based on the test result information, the supplementary-setting-table information, and the topology information.
